(19) United States
(12) Patent Application Publication
(10) Pub. No.: US 2025/0080036 A1
(43) Pub. Date: Mar. 6, 2025

(54) ADJUSTABLE MOUNTING ASSEMBLY FOR ATTACHMENT TO A TRAPEZOIDAL RIB OF A METAL PANEL

(71) Applicant: RMH TECH LLC, Colorado Springs, CO (US)

(72) Inventors: Jonathon Moss, Grandview, TX (US); Dustin M.M. Haddock, Colorado Springs, CO (US)

(21) Appl. No.: 18/820,960

(22) Filed: Aug. 30, 2024

Related U.S. Application Data
(60) Provisional application No. 63/623,045, filed on Jan. 19, 2024.
(60) Provisional application No. 63/579,711, filed on Aug. 30, 2023.

(51) Int. Cl. H02S 20/23

(52) U.S. Cl. CPC H02S 20/23

(57) ABSTRACT

A mounting assembly configured to engage trapezoidal ribs extending from metal panels is disclosed. The mounting assembly includes a mounting bracket and a PV mount. The mounting bracket comprises a base comprising a first leg and a second leg that are adjustably connected by a bolt. Each leg has a foot with an aperture to receive a shaft of a fastener that can extend through a sidewall of a trapezoidal rib when the mounting bracket is secured to the trapezoidal rib. The distance between the two feet may be adjusted by loosening the bolt to fit trapezoidal ribs of different dimensions. The PV mount is selectively connectable to the base by the bolt. In some embodiments, the PV mount includes at least one platform for a photovoltaic module.

### CROSS-REFERENCE TO RELATED APPLICATIONS

This application claims the benefit of priority under 35 U.S.C. § 119 (e) to U.S. Provisional Patent Application No. 63/623,045, filed on Jan. 19, 2024; and to U.S. Provisional Patent Application No. 63/579,711, filed on Aug. 30, 2023; the entirety of each of which is incorporated herein by reference.

### FIELD

The present invention generally relates to systems, methods, devices, and assemblies for installing structures on a building surface and, more particularly, to a mounting assembly which is adjustable to fit metal panels with trapezoidal ribs of various sizes and geometries.

### BACKGROUND

Metal panels are frequently used to define surfaces of buildings such as roofs and sidewalls. One type of metal panel is a trapezoidal rib panel. The trapezoidal rib panel may include one or more trapezoidal ribs. Each trapezoidal rib includes an upper wall that is typically a flat or planar surface. A pair of sidewalls extend downwardly at an oblique angle from the upper wall to base sections on either side of the rib.

It is often desirable to install various types of structures and accessories on building surfaces which include trapezoidal ribs. For example, snow guards or stops, signs, banners, light fixtures, piping, antennas, roof walkways, lightning protection systems, condensate lines, stack/flue bracing, fascia's, equipment screens, electrical conduit and cabling, heating, air conditioning, ventilation equipment, and photovoltaic or solar modules may be installed on metal panels with mounting assemblies that engage the trapezoidal ribs. However, trapezoidal ribs are produced by many different manufacturers and come in a variety of different sizes and geometries. A mounting assembly configured to engage a first trapezoidal rib with a first geometry frequently cannot be reliably (or safely) secured to a second trapezoidal rib with a second geometry that is different than the first geometry.

Accordingly, there is a need for a mounting bracket that is adjustable to accommodate a variety of different trapezoidal ribs which have different profiles and dimensions.

### SUMMARY

An aspect of the present disclosure is an adjustable mounting bracket comprising a first leg moveably interconnected to a second leg by a shaft of a fastener. The first leg is moveable relative to the shaft and the second leg to facilitate adjustment of the mounting bracket for installation on a number of different trapezoidal rib profiles which have a different configuration and/or size. In one embodiment, in a first configuration, a minimum width between a first foot of the first leg and a second foot of the second leg is about 0.67 inches (17.04 mm). In a second configuration, the minimum width between the first foot and the second foot is about 3.75 inches (95.18 mm).

In at least one embodiment, the first leg and the second leg are each formed from a single piece of metal. Accordingly, the first leg and the second leg may be described as being of one-piece construction (e.g., multiple components are not separately attached, welded, or joined together to define either the first leg or the second leg). Thus, in at least some embodiments, the first leg and the second leg do not include any seam joints between adjacent portions thereof.

The first and second legs of the adjustable mounting bracket of the first aspect are formed of a metallic material. In some embodiments, the metallic material is an aluminum alloy. However, other metal alloys may be used to form the adjustable mounting bracket.

In embodiments, the first and second legs are formed from a coil of the metallic material. In at least one embodiment, the metallic material is about 0.125 inches (3.175 mm) thick. The legs are formed by progressive stamping and forming operations as the metallic material of the coil is indexed through a forming apparatus.

Another aspect of the present disclosure is directed to a mounting bracket with a width that is adjustable to engage a trapezoidal rib projecting from a building surface. The mounting bracket includes a first leg having a first flange with a first aperture, and a first foot connected to the first flange by a first bend, where the first foot includes a first outer surface, a first inner surface opposite the first outer surface, and a first hole extending through the first inner surface and the first outer surface, and where a first portion of the first inner surface faces a first rib sidewall of a trapezoidal rib when the mounting bracket is secured to the trapezoidal rib. The mounting bracket includes a second leg having a second flange with a second aperture, and a second foot connected to the second flange by a second bend. The second foot includes a second outer surface, a second inner surface opposite the second outer surface, and a second hole extending through the second inner surface and the second outer surface, where a first portion of the second inner surface faces a second rib sidewall of the trapezoidal rib when the mounting bracket is secured to the trapezoidal rib. The mounting bracket includes a fastener comprising a shaft operable to extend through the first and second apertures to interconnect the first leg to the second leg at a point of interconnection.

In embodiments, the first foot extends from the first leg in a longitudinal direction, and the second foot extends from the second leg in the same longitudinal direction.

In embodiments, the first foot comprises a first upper segment connected to a first lower segment by a first fold, wherein the first portion of the first inner surface is associated with the first lower segment of the first foot. In embodiments, the second foot comprises a second upper segment connected to a second lower segment by a second fold, wherein the first portion of the second inner surface is associated with the second lower segment of the second foot.

In embodiments, the first fold extends from the first flange approximately perpendicular to a first surface of the first flange. In embodiments, the second fold extends from the second flange approximately perpendicular to a first surface of the second flange.

In embodiments, the first upper segment of the first foot is oriented at a first oblique angle to the first lower segment of the first foot. In embodiments, the second upper segment of the second foot is oriented at a second oblique angle to the second lower segment of the second foot.

In embodiments, at least one of the first upper segment of the first foot, the first lower segment of the first foot, the second upper segment of the second foot, and the second lower segment of the second foot are generally planar.

In embodiments, the first bend is formed between the first flange and at least one of the first lower segment and the first upper segment of the first foot; and/or the second bend is formed between the second flange and at least one of the second lower segment and the second upper segment of the second foot.

In embodiments, the first aperture of the first flange is a first elongated slot. In embodiments, the second aperture of the second flange is a second elongated slot.

In embodiments, at least one of the first aperture and the second aperture is unthreaded.

In embodiments, the first leg is of a one-piece construction and is formed from a single piece of a metal material. In embodiments, the second leg is of a one-piece construction and is formed from a single piece of the metal material.

In embodiments, the first hole extends through the first portion of the first inner surface such that a shaft of a first fastener is extendable through the first hole and the first rib sidewall to terminate in a hollow interior of the trapezoidal rib when the mounting bracket is secured to the trapezoidal rib.

In embodiments, the mounting bracket includes an angle bracket. The angle bracket includes a first arm with one or more of a first opening and a second opening. The angle bracket includes a second arm with an attachment aperture, where the shaft of the fastener is selectively extendable through either the first opening or the second opening to interconnect the angle bracket to the first leg and the second leg.

In embodiments, the shaft of the fastener defines a pivot axis, and wherein the first leg and the second leg are selectively rotatable around the pivot axis after interconnection of the first leg to the second leg via the shaft of the fastener.

In embodiments, the first foot extends in a first longitudinal direction from a point of interconnection of the first leg to the second leg. Optionally, the second foot extends in a second opposite longitudinal direction from the point of interconnection.

In embodiments, the mounting bracket includes at least one of a first gasket selectively engaged to the first portion of the first inner surface of the first foot such that the first gasket covers the first hole, and a second gasket selectively engaged to the first portion of the second inner surface of the second foot such that the second gasket covers the second hole.

A third aspect of the present disclosure is directed to a mount to interconnect a photovoltaic module to a mounting bracket having an adjustable width and that is securable to a trapezoidal rib projecting from a building surface. The mount includes a body with a top end including a top surface. The mount includes a top aperture extending through the top surface. The mount includes a first PV platform extending outward from a first side of the mount, wherein the first PV platform comprises a first upper surface adapted to selectively support the photovoltaic module. The mount includes an orifice extending through the first side of the mount, the orifice configured to receive a shaft of a fastener to interconnect the mount to the mounting bracket.

In embodiments, the mount includes a groove within the first upper surface of the first PV platform, wherein the groove is operable to receive a grounding insert with at least one dimple that extends upward to engage a frame of the photovoltaic module when selectively supported.

In embodiments, the grounding insert received by the groove of the first upper surface of the first PV platform includes one or more hooks to engage one or more ends of the first PV platform. In embodiments, the grounding insert received by the groove of the second upper surface of the second PV platform includes one or more hooks to engage one or more ends of the second PV platform.

In embodiments, a second PV platform extending outward from a second opposite side of the mount, where the second PV platform comprises a second upper surface adapted to selectively support a second photovoltaic module.

In embodiments, the mount further includes a groove within the second upper surface of the second PV platform, where the groove is operable to receive a grounding insert with at least one dimple that extends upward from the second upper surface to engage a frame of the second photovoltaic module when selectively supported.

In embodiments, the first PV platform is a first length in a first direction of extension outward from the first side of the mount. The second PV platform is a second length in a second direction of extension outward from the second opposite side of the mount. The first length is longer than the second length.

In embodiments, the first PV platform has a first stop proximal to the first side of the mount, where a frame of the photovoltaic module makes contact with the first stop when selectively supported by the first PV platform, and where the first stop is configured to space the frame of the photovoltaic module a first predetermined distance from a central reference plane through the body. The second PV platform has a second stop proximal to the second opposite side of the mount, where a frame of the second photovoltaic module makes contact with the second stop when selectively supported by the second PV platform, and where the second stop is configured to space the frame of the second photovoltaic module a second predetermined distance from the central reference plane through the body. The second predetermined distance is substantially equal to the first predetermined distance.

In embodiments, a portion of the first upper surface of the first PV platform and a portion of the second upper surface of the second PV platform are each approximately planar. The first upper surface of the first PV platform and the second upper surface of the second PV platform are approximately co-planar.

In embodiments, a cavity extends through the body between a first end and a second end of the body.

In embodiments, the top aperture extends through the top surface and into the cavity.

In embodiments, the top aperture is threaded, where an interior thread of the top aperture has a thread pitch, and where the depth of the top aperture is at least 2.5 times greater than the thread pitch such that an exterior thread of a clamp fastener engaged to the interior thread will have at least 2.5 revolutions within the top aperture to prevent thread failure.

In embodiments, the mount includes a mount flange extending from a second opposite side of the mount, where the first PV platform is positioned between the mount flange and the top surface in a vertical dimension.

In embodiments, the mount flange is positioned between the first PV platform and the orifice in the vertical dimension such that contact between the mount flange and the mounting bracket will prevent inadvertent rotation of the mounting bracket around an axis of the fastener when the mount flange is interconnected to the mounting bracket.

A fourth aspect of the present disclosure is directed to a mounting system to engage a trapezoidal rib projecting from a building surface and secure a photovoltaic module to the building surface. The mounting system includes a mounting bracket with an adjustable width. The mounting bracket includes a first leg having a first flange with a first aperture, and a first foot connected to the first flange by a first bend, where a first portion of a first inner surface of the first foot faces a first rib sidewall of the trapezoidal rib when the mounting bracket is secured to the trapezoidal rib. The mounting bracket includes a second leg having a second flange with a second aperture, and a second foot connected to the second flange by a second bend, where a first portion of a second inner surface of the second foot faces a second rib sidewall of the trapezoidal rib when the mounting bracket is secured to the trapezoidal rib. The mounting bracket includes a fastener comprising a shaft operable to extend through the first and second apertures to interconnect the first leg to the second leg at a point of interconnection. The mounting system includes a mount to interconnect the photovoltaic module to the mounting bracket. The mount includes a body with a top end including a top surface. The mount includes a top aperture extending through the top surface. The mount includes a first PV platform extending outward from a first side of the mount, where the first PV platform comprises a first upper surface adapted to selectively support the photovoltaic module. The mount includes an orifice extending through the first side of the mount, the orifice configured to receive the shaft of the fastener to interconnect the mount to the mounting bracket at the point of interconnection.

In embodiments, the mounting system further includes a clamp adapted to selectively support the photovoltaic module, the clamp couplable to the top end of the mount. The clamp includes a first leg and a second leg defining a cavity therebetween, where the top surface has a width that is less than a width of the cavity defined between the first leg and the second leg, and where a portion of the body proximate the top end has a second width that is greater than the width of the cavity such that the first leg provides a friction fit with at least the first side of the mount when the clamp is coupled to the top end of the mount.

In embodiments, the mounting system further includes a second PV platform extending outward from a second opposite side of the mount, wherein the second PV platform comprises a second upper surface adapted to selectively support a second photovoltaic module.

In embodiments, the first foot includes a first outer surface, a first inner surface opposite the first outer surface, and a first hole extending through the first inner surface and the first outer surface. Optionally, the second foot includes a second outer surface, a second inner surface opposite the second outer surface, and a second hole extending through the second inner surface and the second outer surface.

In embodiments, the mounting system includes a groove within the first upper surface of the first PV platform of the mount, wherein the groove is operable to receive a grounding insert with at least one dimple that extends upward from the first upper surface to engage a frame of the photovoltaic module when selectively supported.

In embodiments, the mounting system includes a groove within the second upper surface of the second PV platform of the mount, wherein the groove is operable to receive a grounding insert with at least one dimple that extends upward from the second upper surface to engage a frame of the second photovoltaic module when selectively supported.

In embodiments, the mounting system includes a clamp adapted to selectively support the photovoltaic module and the second photovoltaic module, the clamp couplable to the top end of the mount, the clamp including a first leg and a second leg defining a cavity therebetween, wherein the top end has a width that is less than a width of the cavity defined between the first leg and the second leg such that the first leg and the second leg provides a friction fit with at least the first side of the mount when the clamp is coupled to the top end of the mount.

A fifth aspect of the present disclosure is directed to a mount to interconnect a photovoltaic module to a mounting element that is securable to a building surface. The mount includes a body including a first side and a second side. The mount includes a cavity defined by the first side and the second side, the cavity configured to receive a shaft of a fastener during interconnection of the mount to the mounting element. The mount includes a first aperture within the body, the first aperture being alignable with a second aperture in the mounting element during interconnection of the mount to the mounting element. The mount includes a first PV platform extending outward from the first side, where the first PV platform comprises a first upper surface adapted to selectively support the photovoltaic module.

In embodiments, the mount interconnects a second photovoltaic module to the mounting element. The mount further includes a second PV platform extending outward from the second side, where the second PV platform comprises a second upper surface adapted to selectively support the second photovoltaic module.

A sixth aspect is to provide a mounting bracket with a width that is adjustable to engage trapezoidal ribs of a variety of sizes, comprising: (1) a first leg comprising: (a) a first flange with a first aperture; and (b) a first foot connected to the first flange by a first bend, the first foot comprising a first outer surface which is oriented approximately perpendicular to the first flange, a first inner surface opposite the first outer surface, and a first hole extending through the first inner surface and the first outer surface such that a first portion of the first inner surface faces a first rib sidewall of a trapezoidal rib when the mounting bracket is secured to the trapezoidal rib; (2) a second leg comprising: (a) a second flange with a second aperture; and (b) a second foot connected to the second flange by a second bend, the second foot comprising a second outer surface which is oriented approximately perpendicular to the second flange, a second inner surface opposite the second outer surface, and a second hole extending through the second inner surface and the second outer surface such that a first portion of the second inner surface faces a second rib sidewall of the trapezoidal rib when the mounting bracket is secured to the trapezoidal rib; and (3) a fastener comprising a shaft operable to extend through the first and second apertures to interconnect the first leg to the second leg.

In some embodiments, at least one of the first and second apertures is unthreaded.

In one or more embodiments, at least one of the first aperture and the second aperture is elongated to define a slot.

The mounting bracket of the sixth aspect may include one or more of the previous embodiments, and optionally the first hole extends through the first portion of the first inner surface such that a shaft of a first fastener is extendable through the first hole to engage the first rib sidewall to secure the mounting bracket to the trapezoidal rib.

Optionally, the first fastener may extend through the first rib sidewall to terminate in a hollow interior of the trapezoidal rib when the mounting bracket is secured to the trapezoidal rib.

Additionally, or alternatively, the mounting bracket of the sixth aspect may include one or more of the previous embodiments, and optionally the second hole extends through the first portion of the second inner surface such that a second fastener is extendable through the second hole to engage the second rib sidewall to secure the mounting bracket to the trapezoidal rib.

In some embodiments, the second fastener may extend through the second rib sidewall to terminate in a hollow interior of the trapezoidal rib when the mounting bracket is secured to the trapezoidal rib.

The mounting bracket of the sixth aspect may include one or more of the previous embodiments, and optionally one or more of the first hole and the second hole is unthreaded.

In at least one embodiment, one or more of the first fastener and the second fastener is threaded.

The mounting bracket of the sixth aspect may include one or more of the previous embodiments, and optionally comprises a first gasket selectively engaged to the first portion of the first inner surface of the first foot such that the first gasket covers the first hole.

In one or more embodiments, the first portion of the first inner surface is generally planar.

Optionally, a first section of the first outer surface is generally planar, the first section of the first outer surface being opposite to the first portion of the first inner surface.

Additionally, or alternatively, in some embodiments the first portion of the second inner surface is generally planar.

In at least one embodiment, a first section of the second outer surface is generally planar, the first section of the second outer surface being opposite to the first portion of the second inner surface.

The mounting bracket of the sixth aspect may include one or more of the previous embodiments, and in some embodiments the first foot comprises a first upper segment connected to a first lower segment by a first fold.

Optionally, the first upper segment is oriented at an oblique angle to the first lower segment.

Additionally, or alternatively, the first portion of the first inner surface is optionally associated with the first lower segment of the first foot.

In some embodiments, no apertures extend through the first upper segment.

In at least one embodiment, the first inner surface comprises a second portion which faces an upper surface of an upper wall of the trapezoidal rib when the mounting bracket is secured to the trapezoidal rib. In some embodiments, the second portion of the first inner surface is associated with the first upper segment.

In one or more embodiments, the first fold extends approximately perpendicular to a first surface of the first flange.

The mounting bracket of the sixth aspect may include one or more of the previous embodiments, and in some embodiments the second foot comprises a second upper segment connected to a second lower segment by a second fold.

Optionally, the second upper segment is oriented at an oblique angle to the second lower segment.

Additionally, or alternatively, the first portion of the second inner surface is optionally associated with the second lower segment of the second foot.

In some embodiments, no apertures extend through the second upper segment.

In at least one embodiment, the second inner surface comprises a second portion which faces the upper surface of the trapezoidal rib when the mounting bracket is secured to the trapezoidal rib.

In some embodiments, the second portion of the second inner surface is associated with the second upper segment.

In one or more embodiments, the second fold extends approximately perpendicular to a first surface of the second flange.

The mounting bracket of the sixth aspect may include one or more of the previous embodiments, and in some embodiments the first leg is of a one-piece construction and is formed from a single piece of a metal material.

Additionally, or alternatively, in at least one embodiment the second leg is of a one-piece construction and is formed from a single piece of the metal material.

In some embodiments, the first flange has a first thickness and the first foot has a second thickness which is approximately equal to the first thickness.

Optionally, the second flange has a third thickness and the second foot has a fourth thickness. In at least one embodiment, the third and fourth thicknesses are approximately equal to the first thickness.

In one or more embodiments, the first outer surface comprises a first end and a second end, the first end positioned proximate to the first bend and the first flange.

In some embodiments, the first flange comprises a first surface facing away from the first bend and a second surface opposite to the first surface, the second surface facing the first bend. In these embodiments, the first surface defines a first reference plane that does not intersect any portion of the first leg.

The mounting bracket of the sixth aspect may include one or more of the previous embodiments, and optionally further comprises a first bulge intersecting the first bend and extending from the first foot toward the second end of the first outer surface.

In some embodiments, the second surface of the first flange defines a second reference plane that intersects the first bulge and the first foot.

The mounting bracket of the sixth aspect may include one or more of the previous embodiments, and optionally further comprises a pivot axis defined by the shaft of the fastener such that the first leg and the second leg are selectively rotatable around the pivot axis.

The mounting bracket of the sixth aspect may include one or more of the previous embodiments, and optionally further comprises an attachment that is selectively secured to the mounting bracket. In some embodiments, the attachment is an angle bracket. Alternatively, in other embodiments, the attachment is a photovoltaic (PV) mount.

The angle bracket optionally comprises: (i) a first arm with one or more of a first opening and a second opening; and (ii) a second arm with an attachment aperture. The first and second openings are configured such that the shaft of the fastener is selectively extendable through either the first opening or the second opening to interconnect the angle bracket to the first leg and the second leg.

In at least one embodiment, when the shaft extends through the first opening of the angle bracket, the angle bracket is selectively rotatable up to 360 degrees around the shaft without obstruction from the first leg or the second leg.

The mounting bracket of the sixth aspect may include one or more of the previous embodiments, and optionally further comprises a mount for a photovoltaic module, the mount being selectively attachable to the mounting bracket by the fastener.

In at least one embodiment, the mount comprises: (1) an orifice that is selectively alignable with the first and second apertures, the shaft of the fastener being extendable through the orifice and the first and second apertures to interconnect the mount to the mounting bracket; (2) a top surface; (3) a top aperture extending through the top surface; and (4) a first photovoltaic (PV) platform extending from a first side of the mount, with the first PV platform comprising a first upper surface adapted to selectively support the photovoltaic module.

The mounting bracket may include one or more of the previous embodiments, and optionally the orifice is unthreaded.

In one or more embodiments, the orifice is elongated in a vertical dimension to define a slot.

The mounting bracket may include one or more of the previous embodiments, and the top aperture is optionally threaded.

The mounting bracket of the sixth aspect may include any of the previous embodiments, and optionally further comprises a mount flange extending from a second side of the mount.

In some embodiments, the first PV platform is positioned between the mount flange and the top surface in a vertical dimension.

Optionally, the orifice is positioned between the mount flange and a bottom end of the mount in a vertical dimension.

In at least one embodiment, the mount flange extends away from the second side in a longitudinal dimension that is orthogonal to a vertical dimension.

In one or more embodiments, the mount flange extends in a lateral dimension from a first end to a second end of the mount, the lateral dimension being orthogonal to a vertical dimension and a longitudinal dimension.

The mounting bracket of the sixth aspect optionally includes any of one or more of the previous embodiments, and when the mount is interconnected to the mounting bracket with the second side facing the first and second legs, the mount flange may selectively contact side surfaces of the first and second flanges to prevent rotation of the mount around a pivot axis defined by the shaft of the fastener.

In some embodiments, the mount further comprises: (a) a first end spaced from a second end in a lateral dimension which is orthogonal to a vertical dimension; and (b) a cavity extending through the mount from the first end to the second end.

In at least one embodiment, the cavity is positioned between the first PV platform and the top surface in the vertical dimension.

Optionally, the top aperture extends to the cavity.

The mounting bracket of the sixth aspect may include any of one or more of the previous embodiments, and in some embodiments the first upper surface of the first PV platform is generally planar.

In at least one embodiment, the first PV platform comprises a first groove recessed downwardly in the vertical dimension relative to the first upper surface, the first groove extending in a lateral dimension.

Optionally, the mounting bracket further comprises a grounding insert configured to fit at least partially into the first groove such that an upward surface of the grounding insert is approximately co-planar with the first upper surface of the first PV platform when the grounding insert is engaged to the first PV platform.

In some embodiments, the grounding insert comprises: (a) a first hook to engage a first end of the first PV platform; and (b) a second hook to engage a second end of the first PV platform.

Optionally, the grounding insert further comprises a dimple extending from the upward surface such that the dimple projects above the first upper surface of the first PV platform when the grounding insert is engaged to the first PV platform.

In one or more embodiments, the grounding insert is formed of a metal such as a stainless steel.

The mounting bracket may include one or more of the previous embodiments, and the first PV platform further comprises a first stop extending from the first upper surface in a vertical dimension.

In some embodiments, the first stop is positioned between the first groove and the first side of the mount.

Optionally, the first stop is configured to space a frame of the photovoltaic module a predetermined distance from a central reference plane extending in the vertical dimension and the lateral dimension and through the top aperture.

The mounting bracket of the sixth aspect may include any of one or more of the previous embodiments, and the mounting bracket may optionally further comprise a second PV platform extending from the second side of the mount, the second PV platform comprising a second upper surface adapted to selectively support a second photovoltaic module.

Optionally, the second PV platform is positioned between the mount flange and the top surface in the vertical dimension.

In at least one embodiment, the second upper surface of the second PV platform is generally planar.

In embodiments, the second upper surface is approximately co-planar with the first upper surface of the first PV platform.

In one or more embodiments, the second PV platform comprises a second groove recessed downwardly in the vertical dimension relative to the second upper surface, the second groove extending in the lateral dimension.

Optionally, the second PV platform further comprises a second stop extending from the second upper surface in the vertical dimension.

In some embodiments, the second stop is positioned between the second groove and the second side of the mount.

The second stop is optionally configured to space a frame of the second photovoltaic module a predetermined distance from the central reference plane.

In one or more embodiment: (a) the first PV platform extends a first distance in the longitudinal dimension; and (b) the second PV platform extends a second distance in the longitudinal dimension, the second distance being less than the first distance.

The mounting bracket of the sixth aspect may include any of one or more of the previous embodiments, and optionally the mount is of a one-piece construction and is formed from a single piece of the metal material.

In some embodiments, the metal material is an aluminum.

A seventh aspect of the present disclosure is to provide a mount to interconnect a photovoltaic (PV) module to a mounting bracket securable to a rib projecting from a surface of a building, the mount comprising: (a) an orifice configured to receive a shaft of a fastener to interconnect the mount to the mounting bracket; (b) a top surface; (c) a top aperture extending through the top surface; and (d) a first photovoltaic (PV) platform extending from a first side of the mount, the first PV platform comprising a first upper surface adapted to selectively support the photovoltaic module.

In some embodiments, the orifice is unthreaded.

Optionally, the orifice is elongated in a vertical dimension to define a slot.

In at least one embodiment, the top aperture is threaded.

In some embodiments, an interior thread of the top aperture has a thread pitch, and the depth of the top aperture is at least four time greater than the thread pitch such that an exterior thread of a clamp fastener engaged to the interior thread will have at least 2.5 revolutions, and in some instances at least four revolutions, within the top aperture to prevent thread failure.

The mount of the seventh aspect may include any of one or more of the previous embodiments, and optionally further comprises a mount flange extending from a second side of the mount.

In some embodiments, the first PV platform is positioned between the mount flange and the top surface in the vertical dimension.

Optionally, the orifice is positioned between the mount flange and a bottom end of the mount in the vertical dimension.

In embodiments, the mount flange extends away from the second side in a longitudinal dimension that is orthogonal to the vertical dimension.

In one or more embodiments, the mount flange extends in a lateral dimension from a first end to a second end of the mount, the lateral dimension being orthogonal to the vertical dimension and the longitudinal dimension.

Optionally, when the mount is interconnected to the mounting bracket with the second side facing the mounting bracket, the mount flange may selectively contact one or more portions of the mounting bracket to prevent rotation of the mount around a pivot axis defined by the shaft of the fastener.

The mount of the seventh aspect may include any of one or more of the previous embodiments, and optionally the mount further comprises: (a) a first end spaced from a second end in the lateral dimension which is orthogonal to the vertical dimension; and (b) a cavity extending through the mount from the first end to the second end.

In some embodiments, the cavity is positioned between the first PV platform and the top surface in the vertical dimension.

In at least one embodiment, the top aperture extends to the cavity.

In some embodiments, the first upper surface of the first PV platform is generally planar.

Optionally, the first PV platform comprises a first groove recessed downwardly in the vertical dimension relative to the first upper surface, the first groove extending in the lateral dimension.

The mount of the seventh aspect can include any of one or more of the previous embodiments, and optionally the mount further comprises a grounding insert configured to fit at least partially into the first groove such that an upward surface of the grounding insert is approximately co-planar with the first upper surface of the first PV platform when the grounding insert is engaged to the first PV platform.

Optionally, the grounding insert comprises: (a) a first hook to engage a first end of the first PV platform; and (b) a second hook to engage a second end of the first PV platform.

In some embodiments, the grounding insert further comprises a dimple extending from the upward surface such that the dimple projects above the first upper surface of the first PV platform when the grounding insert is engaged to the first PV platform.

In at least one embodiment, the grounding insert is formed of a metal such as a stainless steel.

In some embodiments, the first PV platform further comprises a first stop extending from the first upper surface in the vertical dimension.

Optionally, the first stop is positioned between the first groove and the first side of the mount.

In one or more embodiments, the first stop is configured to space a frame of the photovoltaic module a predetermined distance from a central reference plane extending in the vertical dimension and the lateral dimension and through the top aperture.

The mount of the seventh aspect may include any of one or more of the previous embodiments, and optionally further comprises a second PV platform extending from the second side of the mount, the second PV platform comprising a second upper surface adapted to selectively support a second photovoltaic module.

In some embodiments, the second PV platform is positioned between the mount flange and the top surface in the vertical dimension.

In at least one embodiment, the second upper surface of the second PV platform is generally planar.

Optionally, the second upper surface is approximately co-planar with the first upper surface of the first PV platform.

In one or more embodiments, the second PV platform comprises a second groove recessed downwardly in the vertical dimension relative to the second upper surface, the second groove extending in the lateral dimension.

Optionally, the second PV platform further comprises a second stop extending from the second upper surface in the vertical dimension.

In one or more embodiments, the second stop is positioned between the second groove and the second side of the mount in the longitudinal dimension.

In some embodiments, the second stop is configured to space a frame of the second photovoltaic module a predetermined distance from the central reference plane.

In at least one embodiment, (a) the first PV platform extends a first distance in the longitudinal dimension; and (b) the second PV platform extends a second distance in the longitudinal dimension, the second distance being less than the first distance.

The mount of the seventh aspect may include any of one or more of the previous embodiments, and optionally the mount is of a one-piece construction and is formed from a single piece of the metal material.

In some embodiments, the metal material is an aluminum.

Optionally, the mount is an extrusion.

One or more means for performing any of one or more of the above aspects or aspects of the embodiments described herein.

Any aspect in combination with any of one or more other aspects.

Any one or more of the features disclosed herein.

Any one or more of the features as substantially disclosed herein.

Any one or more of the features as substantially disclosed herein in combination with any of one or more other features as substantially disclosed herein.

Any one of the aspects/features/embodiments in combination with any of one or more other aspects/features/embodiments.

Use of any of one or more of the aspects or features as disclosed herein.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. When used with a number or a range, the terms “about” and “approximately” indicate the number or range may be “a little above” or “a little below” the endpoint with a degree of flexibility as would be generally recognized by those skilled in the art. Further, the terms “about” and “approximately” may include the exact endpoint, unless specifically stated otherwise. Accordingly, unless otherwise indicated, all numbers expressing quantities, dimensions, conditions, ratios, angles, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 10% of the stated value.

The term “parallel” means two objects are oriented at an angle within plus or minus 0° to 5° unless otherwise indicated. Similarly, the terms “perpendicular” and “orthogonal” mean two objects are oriented at angle of from 85° to 95° unless otherwise indicated.

Unless otherwise indicated, the term “substantially” indicates a difference of from 0% to 5% of the stated value is acceptable.

All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112 (f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s).

FIG. 1 is an upper, rear, left side perspective view of a mounting assembly including a mounting bracket, according to embodiments of the present disclosure, in a position of use affixed to a first trapezoidal rib of a roof formed of metal panels;

FIG. 2 is a front elevation view of the mounting bracket of FIG. 1 affixed to a second trapezoidal rib of a different size and geometry than the first trapezoidal rib, and illustrating a clamp system secured to the mounting bracket, the clamp system clamping two photovoltaic modules;

FIG. 3 is an upper, front, right side perspective exploded view of the mounting assembly of FIG. 1 and illustrating the mounting bracket and optionally associated hardware;

FIG. 4 is a top plan view of the mounting bracket and an angle bracket of FIG. 1;

FIG. 5 is a right side elevation view of the mounting bracket and the angle bracket of FIG. 1;

FIG. 6 is a front elevation view of the mounting bracket of FIG. 1 in a first configuration;

FIG. 7 is another front elevation view of the mounting bracket of FIG. 6 in a second configuration;

FIG. 8A is an upper, front, right side perspective view of a left leg of the mounting bracket of FIG. 1;

FIG. 8B is a front elevation view of the left leg of FIG. 8A;

FIG. 8C is a rear elevation view of the left leg of FIG. 8A;

FIG. 8D is a top plan view of the left leg of FIG. 8A;

FIG. 8E is a bottom plan view of the left leg of FIG. 8A;

FIG. 8F is a left elevation view of the left leg of FIG. 8A;

FIG. 8G is a right elevation view of the left leg of FIG. 8A;

FIG. 9A is an upper, front, right side perspective view of a right leg of the mounting bracket of FIG. 1;

FIG. 9B is a front elevation view of the right leg of FIG. 9A;

FIG. 9C is a rear elevation view of the right leg of FIG. 9A;

FIG. 9D is a top plan view of the right leg of FIG. 9A;

FIG. 9E is a bottom plan view of the right leg of FIG. 9A;

FIG. 9F is a left elevation view of the right leg of FIG. 9A;

FIG. 9G is a right elevation view of the right leg of FIG. 9A;

FIG. 10A is an upper, front, right side perspective view of a mounting assembly including a mounting bracket, according to embodiments of the present disclosure;

FIG. 10B is an upper, front, right side perspective view of first and second legs of the mounting bracket of FIG. 10A;

FIG. 11A is an upper, front, left side perspective view of a mounting assembly including another mounting bracket of the present disclosure;

FIG. 11B is an upper, front, left side perspective view of first and second legs of the mounting bracket of FIG. 11A;

FIG. 12A is a left side elevation view of a mounting assembly including a mount interconnected to a mounting bracket, according to embodiments of the present disclosure, in a position of use, and illustrating a clamp system secured to the mounting bracket, the clamp system clamping a single photovoltaic module;

FIG. 12B is a front, left perspective view of the mounting assembly of FIG. 12A;

FIG. 13A is an upper, rear, right side perspective view of the mount of FIG. 12A;

FIG. 13B is a left side elevation view of the mount of FIG. 13A;

FIG. 13C is a left side cross-sectional view of the mount of FIG. 13A;

FIG. 13D is a front elevation view of the mount of FIG. 13A;

FIG. 13E is a rear elevation view of the mount of FIG. 13A;

FIG. 13F is a top plan view of the mount of FIG. 13A;

FIG. 14A is a left side elevation view of a mounting assembly including a mount interconnected to a mounting bracket according to embodiments of the present disclosure in a position of use, and illustrating a clamp system secured to the mounting bracket, the clamp system clamping two photovoltaic modules;

FIG. 14B is a front, left perspective view of the mounting assembly of FIG. 14A;

FIG. 15A is an upper, rear, right side perspective view of the mount of FIG. 14A;

FIG. 15B is a left side elevation view of the mount of FIG. 15A;

FIG. 15C is a left side cross-sectional view of the mount of FIG. 15A;

FIG. 15D is a front elevation view of the mount of FIG. 15A;

FIG. 15E is a rear elevation view of the mount of FIG. 15A;

FIG. 15F is a top plan view of the mount of FIG. 15A;

FIG. 16A is a perspective view of a grounding insert, according to embodiments of the present disclosure;

FIG. 16B is a front elevation view of the grounding insert of FIG. 16A;

FIG. 16C is a top plan view of the grounding insert of FIG. 16A; and

FIG. 16D is a left side elevation view of the grounding insert of FIG. 16A.

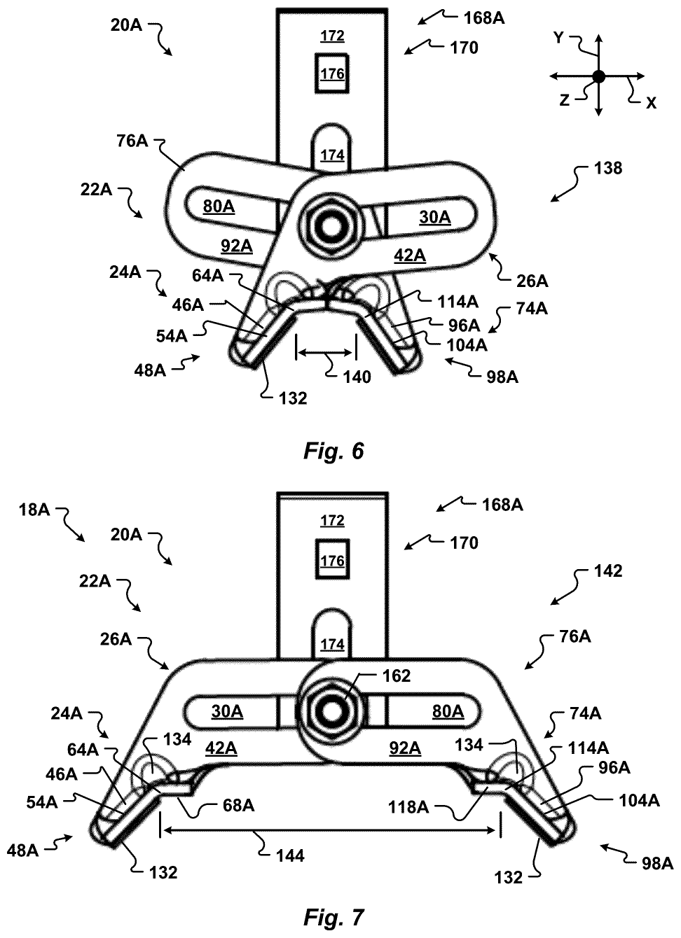

The drawings are not necessarily (but may be) to scale. In particular, FIGS. 6-7, FIGS. 8A-8G, FIGS. 9A-9G, FIGS. 10-10B, FIGS. 11A-11B, FIGS. 13B-13F, FIGS. 15B-15F, and FIGS. 16A-16D are drawn to scale.

In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

The following is a listing of components according to various embodiments of the present disclosure, and as shown in the drawings:

| Number | Component |
|---|---|
| 2 | Roof |
| 4 | Metal panel |
| 6 | Trapezoidal rib |
| 8 | Panel base |
| 10 | Sidewall |
| 12 | Upper wall |
| 14 | Hollow interior |
| 18 | Mounting assembly |
| 20 | Mounting bracket |
| 22 | Base |
| 24 | First leg |
| 26 | First flange |
| 28 | First flange fold |
| 30 | First aperture |
| 32 | Slot length |
| 34 | First surface of first flange |
| 36 | First reference plane |
| 38 | First side of first reference plane |
| 40 | Second side of first reference plane |
| 42 | Second surface of first flange |
| 44 | Second reference plane |
| 46 | First bend |
| 48 | First foot |
| 50 | Segments of first foot |
| 52 | Free end of first foot |
| 54 | First outer surface |
| 56 | First inner surface |
| 58 | First lower segment |
| 60 | First portion of first inner surface |
| 62 | First section of first outer surface |
| 64 | First fold |
| 66 | First upper segment |
| 68 | Second portion of first inner surface |
| 70 | Second section of first outer surface |
| 72 | Length of first foot |
| 74 | Second leg |
| 76 | Second flange |
| 78 | Second flange fold |
| 80 | Second aperture |
| 84 | First surface of second flange |
| 86 | Third reference plane |
| 88 | First side of third reference plane |
| 90 | Second side of third reference plane |
| 92 | Second surface of second flange |
| 94 | Fourth reference plane |
| 96 | Second bend |
| 98 | Second foot |
| 100 | Segments of second foot |
| 102 | Free end of second foot |
| 104 | Second outer surface |
| 106 | Second inner surface |
| 108 | Second lower segment |
| 110 | First portion of second inner surface |
| 112 | First section of second outer surface |
| 114 | Second fold |
| 116 | Second upper segment |
| 118 | Second portion of second inner surface |
| 120 | Second section of second outer surface |
| 122 | Length of second foot |
| 130 | Holes through first and second feet |
| 132 | Gasket |
| 134 | Bulge in first and second bend |
| 136 | Folds between flanges and feet |
| 138 | First configuration |
| 140 | First width of first configuration |
| 142 | Second configuration |
| 144 | Second width of second configuration |
| 150 | Fastener |
| 152 | Head |
| 154 | Square neck |
| 156 | Shaft |
| 158 | Pivot axis |
| 160 | Threads |
| 162 | Nut |
| 164 | Fastener |
| 168 | Attachment |
| 170 | Angle bracket |
| 172 | First arm |
| 174 | First opening |
| 176 | Second opening |
| 178 | Second arm |
| 180 | Attachment aperture |
| 186 | Clamp system |
| 188 | Mounting plate |
| 190 | Stanchion or standoff |
| 192 | PV clamp |
| 193 | Clamp legs |
| 194 | Clamp fastener |
| 195 | Exterior threads of clamp fastener |
| 196 | Photovoltaic module |
| 197 | Cavity |
| 198 | Frame of PV module |
| 199 | Top wall |
| 200 | Mount |
| 202 | Body |
| 204 | First end |
| 206 | Second end |
| 208 | Top end |
| 210 | Top wall |
| 212 | Thickness of top wall |
| 214 | Top surface |
| 216 | Top aperture |
| 218 | Interior thread |
| 220 | Aperture axis |
| 222 | Central reference plane |
| f | Cavity |
| 225 | Protrusions |
| 226 | Maximum width of top end |
| 228 | Ramps |
| 230 | Minimum width of top end |
| 232 | First side |
| 234 | Second side |
| 236 | Planar surface of second side |
| 238 | Bottom end |
| 240 | First PV platform |
| 242 | First upper surface |
| 244 | First platform reference plane |
| 246 | First groove |
| 248 | First stop |
| 250 | First outer surface of first stop |
| 252 | Predetermined distance of stop from central reference plane |
| 254 | First length of first photovoltaic (PV) platform |
| 260 | Mount flange |
| 262 | Flange lower surface |
| 264 | Flange length |
| 270 | Second PV platform |
| 272 | Second upper surface |
| 274 | Second platform reference plane |
| 276 | Second groove |
| 278 | Second stop |
| 280 | Second outer surface of second stop |
| 282 | Second length of second PV platform |
| 290 | Orifice |
| 300 | Grounding insert |
| 302 | Insert body |
| 304 | Upward surface |
| 306 | First end |
| 308 | First hook |
| 310 | Second end |
| 312 | Second hook |
| 314 | Dimple |
| X | Lateral dimension |
| Y | Vertical dimension |
| Z | Longitudinal dimension |
| Z1 | Longitudinal dimension |
| Z2 | Longitudinal dimension |

### DETAILED DESCRIPTION

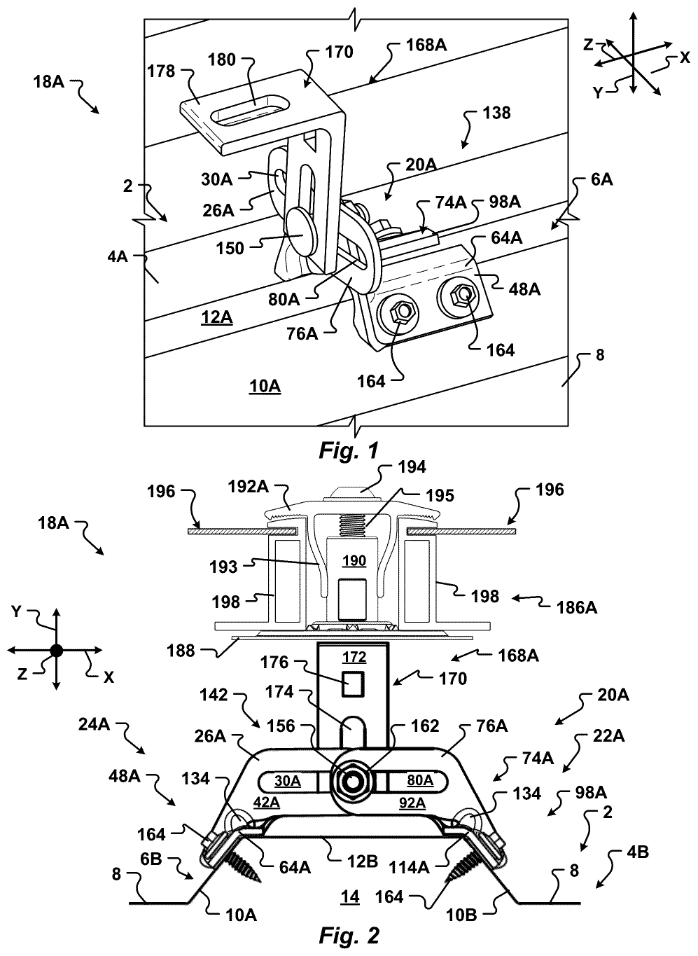

Referring now to FIGS. 1-9, a mounting assembly 18A including a mounting bracket 20A according to embodiments of the present disclosure is generally illustrated. As generally illustrated in FIGS. 1-2, the mounting bracket 20A may be adjusted to fit trapezoidal ribs 6A, 6B of different sizes. The trapezoidal ribs 6 extend from metal panels 4A, 4B that define a roof 2 of a building.

The trapezoidal ribs generally comprise first and second sidewalls 10A, 10B extending from base portions 8 of the metal panel. The sidewalls 10 extend inwardly from the base portions to an upper wall 12 of the respective trapezoidal ribs. The upper wall 12 is positioned a predetermined height above the base portions 8, where the base portions 8 are separated by a predetermined width. The sidewalls are oriented at an oblique angle to the upper wall and the base portions, and the sidewalls 10 are not parallel to each other. The upper wall 12 and the two sidewalls 10A, 10B collectively define a hollow interior 14 of the trapezoidal rib 6. It should be understood that the dimensions of the trapezoidal rib 6 are not limited to that illustrated in FIGS. 1 and 2, and the upper wall and the two sidewalls 10A, 10B may have any dimensional relationship to one another (e.g., resulting in any predetermined height above the base portions 8 and/or predetermined width between the base portions 8), without departing from the scope of the present disclosure.

The mounting bracket 20A generally comprises a base 22A comprising a first leg 24A and a second leg 74A. In some embodiments, the first and second legs are interconnected by a fastener 150 including, but not limited to, a bolt. In one non-limiting example, the fastener 150 may be a carriage bolt that includes a head 152, a square neck 154 extending from the head, and a shaft 156 with external threads 160 that extends from the square neck. The shaft 156 defines a pivot axis 158 around which one or more of the first and second legs 24A, 74A may rotate until a nut 162 is tightened onto the fastener 150.

The first leg 24A is adjustable relative to the fastener 150 and the second leg 74A until the nut 162 is tightened onto a threaded shaft 156 of the fastener 150. Thus, as generally illustrated in FIGS. 1-2 and 6-7, the mounting bracket 20A may be adjusted to a first configuration 138 with a first width 140 to engage a first trapezoidal rib 6A of a first metal panel 4A. As generally illustrated in FIG. 6, in some embodiments, the first width 140 is measured between a first fold 64A of the first leg 24A and a second fold 114A of the second leg 74A. In the first configuration, the first width 140 may be approximately equal to the upper wall 12A of the first trapezoidal rib 6A as generally shown in FIG. 1.

Alternatively, the mounting bracket 20A can also be adjusted to a second configuration 142 with a second width 144 of a different magnitude than the first width. In this manner, in the second configuration 142 the mounting bracket 20A may engage a second trapezoidal rib 6B with different dimensions and geometry (e.g., a different predetermined height and/or predetermined width). Referring again to FIG. 7, in some embodiments, the second width 144 may also be measured between the first fold 64A and the second fold 114A. In the second configuration, the second width 144 may be approximately equal to the upper wall 12B of the second trapezoidal rib 6B as generally shown in FIG. 2.

It is noted that the clamping system 186A (e.g., with mounting plate 188, stanchion 190, clamp 192A, and clamp fastener 194) and the PV modules 196 with frames 198 are not limited to the orientation shown in FIG. 2. For example, the clamping system 186A and the PV modules 196 may be rotated to instead orient in the longitudinal dimension Z as opposed to the lateral dimension X in FIG. 2, with the frames 198 of the PV modules 196 being oriented in the longitudinal dimension Z similar to the legs 26A, 76A (e.g., similar to the PV modules 196 with frame 198 installed in the mounts 200A, 200B, as described in detail further herein). In this regard, FIG. 2 should not be understood as limiting, but merely illustrative of the present disclosure.

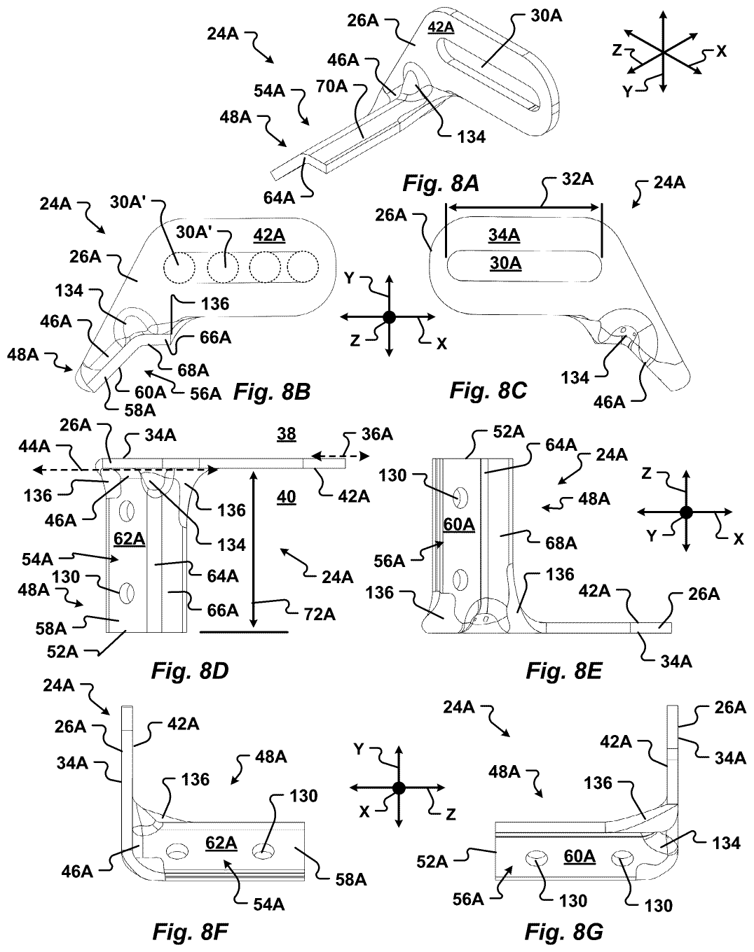

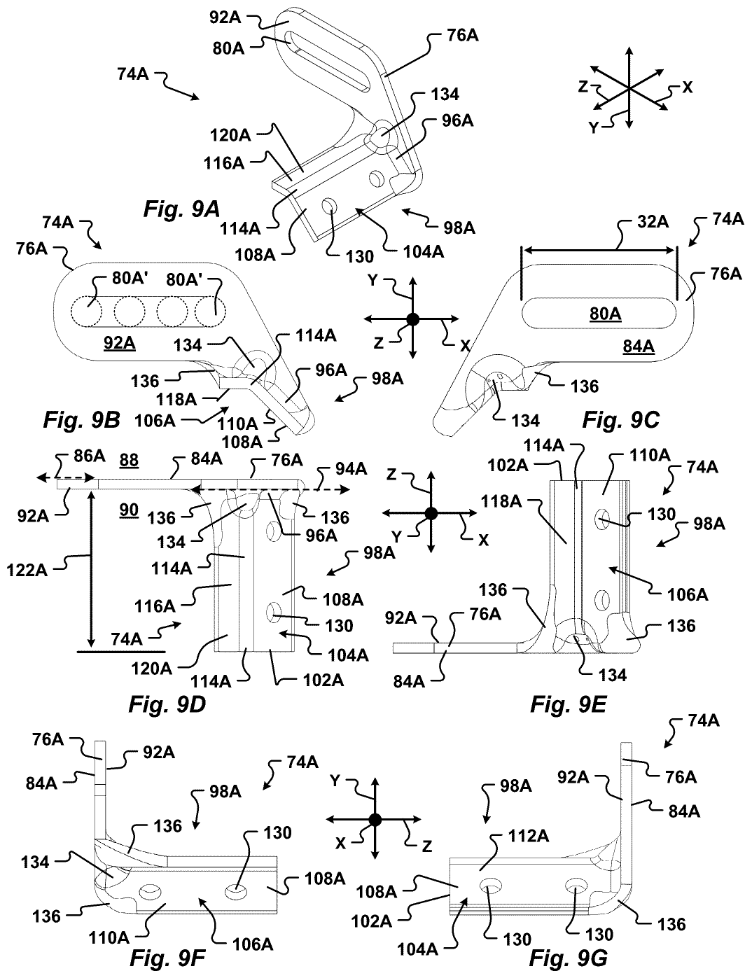

Referring now to FIGS. 8A-8G, the first leg 24A generally comprises a first flange 26A connected to (or extending from) a first foot 48A at a first bend 46A. Similarly, as generally shown in FIG. 9A-9G, the second leg 74A comprises a second flange 76A connected to (or extending from) a second foot 98A at a second bend 96A.

Notably, and in contrast to some prior art mounting brackets, the first leg 24 and the second leg 74 may each be formed from a single piece of metal. More specifically, in embodiments, the first leg and the second leg are formed by cutting, shaping, stamping and/or bending a continuous sheet of metal from a coil. In some embodiments the continuous sheet has a thickness of about 0.125 inches (3.175 mm). The coil is unwound and the continuous sheet is fed into forming apparatus. As the sheet moves in an indexed manner through the forming apparatus, tooling progressively cuts, stamps, shapes and/or forms the first and second legs from the sheet. In this regard, the first leg 24 and the second leg 74 are each of a one-piece construction, and are not welded assemblies formed from multiple pieces or components.

It is noted that forming the legs 24, 74 in this manner is much more efficient and less expensive than methods of forming prior art mounting brackets by cutting multiple pieces of metal that are joined together by welding. For example, each of the left and right legs 24, 74 of all embodiments of the present disclosure can be formed in less time than required to form legs of prior art mounting brackets of approximately the same size that require welding parts together. Further, the first and second legs 24, 74 of the present disclosure require less equipment and less labor to produce compared to legs of prior art mounting brackets. Finally, the use of forming equipment which cuts, stamps, shapes and otherwise forms the left and right legs 24, 74 results in more efficient use of the metal sheet material and less waste of metal compared to the methods used to form legs of prior art mounting brackets of similar size and configuration. In some exemplary configurations, it is contemplated that forming the legs 24, 74 as described throughout the present disclosure results in a 40%-60% decrease in manufacturing cost/increase in manufacturing efficiency, as compared to a mounting bracket formed by cutting and joining together multiple pieces of metal by welding processes.

The first and second flanges 26A, 76A are generally planar. In some embodiments, the first and second flanges each have a thickness of approximately 0.125 inches (3.175 mm) measured in a longitudinal dimension Z.

The first flange has a first surface 34A that faces away from the first bend 46A in the longitudinal dimension Z. A second surface 42A opposite to the first surface 34A faces in the longitudinal dimension Z and toward the first bend 46A.

The first flange 26A has a first aperture 30A and the second flange 76A has a second aperture 80A. The first and second apertures 30A, 80A are sized to receive the threaded shaft 156 of the fastener 150.

In some embodiments, one or more of the first and second apertures 30A, 80A is unthreaded. As generally illustrated in FIG. 8B, the first flange 26A may optionally include two or more first apertures 30A′ that are generally circular. Additionally, or alternatively, the second flange 76A may optionally include two or more second apertures 80A′ that are generally circular as illustrated in FIG. 9B. In some embodiments, the circular apertures 30A′, 80A′ may be formed to correspond to the dimensions of specific trapezoidal ribs 6.

Alternatively, one or more of the first and second apertures 30A, 80A may be elongated to define a slot. In some embodiments, the slot of the first and second apertures has a slot length 32 of between about 1.5 inches and 2 inches, or about 1.8 inches.

It is contemplated that the first flange 26A may optionally include a combination of elongated slot apertures 30A and generally circular apertures 30A′, and/or the second flange 76A may optionally include a combination of elongated slot apertures 80A and generally circular apertures 80A′, without departing from the scope of the present disclosure. For instance, the combination of the apertures 30A, 30A′ on the first flange 26A and/or the combination of the apertures 80A, 80A′ on the second flange 76A may be centrally aligned along an axis in the lateral dimension X, and/or may be offset in a vertical dimension Y.

In at least one embodiment, no projections, protrusions, or extensions are formed on the first surface 34A of the first flange 26A. Accordingly, in embodiments, the first surface 34A defines a first reference plane 36A that does not intersect any portion of the first leg 24A as generally illustrated in FIG. 8D. The first reference plane 36A extends in the lateral dimension X and the vertical dimension Y which are orthogonal to one another.

The first foot 48A extends away from the second surface 42A of the first flange 26A to a free end 52A of the first foot 48A. The free end 52A is thus spaced from the first flange 26A by a predetermined length 72A of the first foot 48A. In some embodiments, the length of the first foot 48A is between about 1 inch and 4 inches. Optionally, the length 72A is between about 1.8 inches and about 2.1 inches, or about 1.9 inches. The length 72A is measured in a longitudinal dimension Z which is orthogonal to the lateral and vertical dimensions X, Y.

The first foot 48A generally comprises a first outer surface 54A, a first inner surface 56A, a first lower segment 58A, and a first upper segment 66A connected to the first lower segment 58A by a first fold 64A. In at least one embodiment, the first fold 64A extends approximately perpendicular to the second surface 42A of the first flange 26A.

It is noted that the first bend 46A may be formed between the first flange 26A, the first lower segment 58A of the first foot 48A, and the first upper segment 66A of the first foot 48A. In this regard, the transition between the first flange 26A and the first foot 26A may be considered seamless, and without a weld or joint.

As generally illustrated in FIG. 8B, the first fold 64A creates an angle of a predetermined magnitude between a first portion 60A of the first inner surface 56A and a second portion 68A of the first inner surface 56A. In some embodiments, the angle has a magnitude of between about 120° and 150°, or about 135°. In general, the first upper segment 66A should be understood as being oriented at an oblique angle to the first lower segment 58A. The angle between the first and second portions 60A, 68A of the first inner surface 56A facilitate engagement between the first foot 48A and trapezoidal ribs 6 of different geometries and sizes.

A hole 130 is formed through the first lower segment 58A. The hole extends through a first section 62A of the first outer surface 54A and through the first portion 60A of the first inner surface 56A.

In some embodiments, the hole is unthreaded. The hole 130 is sized to receive a shaft of a fastener 164 (such as a sheet metal screw, a rivet, or the like) which can extend through the hole and be driven through a first sidewall 10A and into a hollow interior 14 of a trapezoidal rib 6 to fasten the first leg 24A to a metal panel 4 (e.g., as shown in FIG. 2).

In some embodiments, the first foot 48A comprises only one hole 130. Alternatively, in some embodiments the first lower segment has two or more holes 130.

When the first leg 24A is fastened to the trapezoidal rib 6, the first portion 60A of the first inner surface 56A is oriented facing the first sidewall 10A of the trapezoidal rib 6. In some embodiments, at least some of the first portion of the first inner surface may contact the trapezoidal rib as the fastener 164 is tightened to an appropriate degree.

The first upper segment 66A of the first foot 48A is positioned above the upper wall 12 when the first leg 24A is fastened to the trapezoidal rib 6. Accordingly, a second portion 68A of the first inner surface 56A is oriented toward (and may contact at least partially) the upper wall 12A.

Notably, in at least some embodiments, no holes or apertures are formed through the first upper segment 66A. Accordingly, in at least one embodiment, the second portion 68A of the first inner surface 76A and a second section 70A of the first outer surface 54A (which are both associated with the first upper segment 66A of the first foot) have no holes or apertures.

In some embodiments, the first bend 46A between the first flange 26A and the first foot 48A is not linear. Additionally, or alternatively, the first bend 46A may include a bulge 134 and one or more folds 136. In some embodiments, the first leg 24A comprises two folds 136.

The bulge 134 and folds 136 (when present) are formed as a planar piece of a sheet of metal is shaped and the first bend 46A is formed by tooling of the forming apparatus as described above. The bulge and folds account for metal material that is displaced as the metal is shaped to form the first flange and the first foot. Forming the bulge and fold (or folds) to account for the displaced metal material is beneficial because it avoids an operation to cut the planar piece of metal saving a manufacturing step, associated time, and waste of metal material.

Referring to FIG. 8D, the bulge 134 and the one or more folds 136 extend from the second surface 42A of the first flange 26A. Accordingly, a second reference plane 44A defined by a planar portion of the second surface 42A will intersect the bulge and fold. The second reference plane 44A extends in the lateral dimension X and the vertical dimension Y. Further, in at least some embodiments, the second surface 42A may be described as being planar except where the bulge and fold intersect the first flange 26A.

In at least one embodiment, the first foot 48A has a thickness of approximately 0.125 inches (3.175 mm). Accordingly, in at least some embodiments, the thickness of the first foot 48A is approximately equal to the thickness of the first flange 26A since they are formed from the same coiled sheet material.

In embodiments, the second leg 74A has many of the same or similar features as the first leg 24A. In some embodiments, but not necessarily every embodiment of the present disclosure, the second leg 74A is a mirror image of the first leg 24A.

The second flange 76A has a first surface 84A that faces in the longitudinal dimension Z away from the second bend 96A. A second surface 92A opposite to the first surface 84A faces in the longitudinal dimension Z toward the second bend 96A.

In at least one embodiment, no projections, protrusion, or extensions are formed on the first surface 84A of the second flange 76A. Accordingly, in embodiments, the first surface 84A defines a third reference plane 86A that does not intersect any portion of the second leg 74A as generally illustrated in FIG. 9D.

The second foot 98A extends away from the second surface 92A of the second flange 76A to a free end 102A of the second foot 98A. The free end 102A is thus spaced from the second flange 76A by a predetermined length 122A of the second foot 98A. In at least one embodiment, the length 122A of the second foot 98A is approximately equal to the length 72A of the first foot 48A. In some embodiments, the length of the second foot is between about 1 inch and 4 inches. Optionally, the length 122A is about 1.9 inches.

The second foot 98A generally comprises a second outer surface 104A, a second inner surface 106A, a second lower segment 108A, and a second upper segment 116A connected to the second lower segment 108A by a second fold 114A. In at least one embodiment, the second fold 114A extends approximately perpendicular to the second surface 92A of the second flange 76A.

It is noted that the second bend 96A may be formed between the second flange 76A, the second lower segment 108A of the second foot 98A, and the second upper segment 106A of the second foot 98A. In this regard, the transition between the second flange 76A and the second foot 76A may be considered seamless, and without a weld or joint.

As generally illustrated in FIG. 9B, the second fold 114A creates an angle of a predetermined magnitude between a first portion 110A of the second inner surface 106A and a second portion 118A of the second inner surface 106A. In some embodiments, the angle has a magnitude of between about 120° and 150°, or about 135°. In general, the second upper segment 116A should be understood as being oriented at an oblique angle to the second lower segment 108A.

A hole 130 is formed through the second lower segment 108A. The hole extends through a first section 112A of the second outer surface 104A and through the first portion 110A of the second inner surface 106A.

In some embodiments, the hole is unthreaded. The hole 130 is sized to receive a shaft of the fastener 164 such that it can extend through the hole and be driven through a second sidewall 10B and into the hollow interior 14 of the trapezoidal rib 6 to fasten the second leg 74A to the metal panel 4 (e.g., as shown in FIG. 2).

In some embodiments, the second foot 98A comprises only one hole 130. Alternatively, in some embodiments the second lower segment has two or more holes 130.

When the second leg 74A is fastened to the trapezoidal rib 6, the first portion 110A of the second inner surface 106A is oriented facing the second sidewall 10B of the trapezoidal rib 6. In some embodiments, at least some of the first portion of the second inner surface 106A may contact the trapezoidal rib 6 as the fastener 164 is tightened to an appropriate degree.

The second upper segment 116A of the second foot is positioned above the upper wall 12 when the second leg 74A is fastened to the trapezoidal rib 6. Accordingly, a second portion 118A of the second inner surface 106A is oriented toward (and may contact at least partially) the upper wall 12.

Notably, in at least some embodiments, no holes or apertures are formed through the second upper segment 116A. Accordingly, in at least one embodiment, the second portion 118A of the second inner surface 106A and a second section 120A of the second outer surface 104A (which are both associated with the second upper segment 116A of the second foot) have no holes or apertures.

In some embodiments, the second bend 96A between the second flange 76A and the second foot 98A is not linear. Additionally, or alternatively, the second bend 96A may include a bulge 134 and one or more folds 136 similar to the second foot. In some embodiments, the second leg 74A comprises two folds 136. The bulge 134 and folds 136 (when present) are the same as (or similar to) the bulge and folds of the first leg and are formed by the forming apparatus in a similar manner.

Referring to FIG. 9D, the bulge 134 and the one or more folds 136 extend from the second surface 92A of the second flange 76A. Accordingly, a fourth reference plane 94A defined by a planar portion of the second surface 92A will intersect the bulge and fold. Further, in at least some embodiments, the second surface 92A may be described as being planar except where the bulge and fold intersect the second flange 76A.

In one or more embodiments, the second foot 98A has a thickness of approximately 0.125 inches (3.175 mm). Accordingly, in at least some embodiments, the thickness of the second foot 98A is approximately equal to the thickness of the second flange 76A since they are formed from the same coiled sheet material. Further, in some embodiments, the first flange 26A, the second flange 76A, the first foot 48A, and the second foot 98A each have thicknesses that are approximately equal.

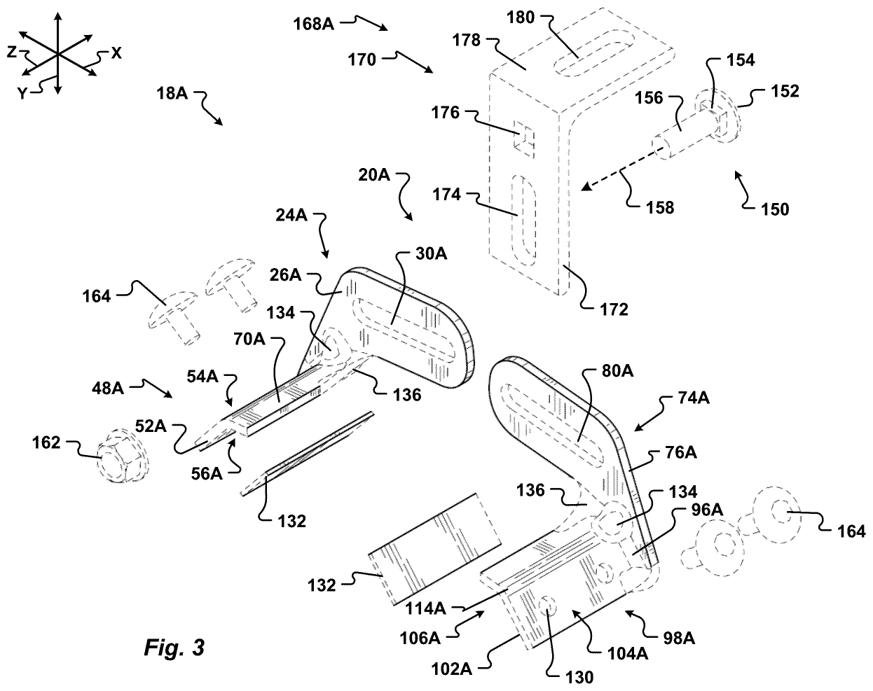

Referring now to FIG. 3, in some embodiments, a gasket 132 of any appropriate type (e.g., an EPDM gasket) is disposed between one or more of the feet 48A, 98A and a corresponding sidewall 10A, 10B of the trapezoidal rib 6. Optionally, gaskets may be applied to the first inner surface 56A of the first foot and to the second inner surface 106A of the second foot. Each gasket 132 may be positioned to cover the one or more holes 130 of the feet. Accordingly, the shaft of the fastener 164 may extend through a hole 130 in a foot 48A, 98A and through the gasket 132 before extending through one of the sidewalls of the trapezoidal rib.

Referring to FIG. 3, an embodiment of an attachment 168 that may be selectively interconnected to the mounting bracket 20 with the fastener 150 is generally illustrated. In some non-limiting examples, the attachment 168 is an angle bracket 170. In other non-limiting examples, the attachment 168 may be a photovoltaic mount 200, as described in detail further herein.

In FIG. 3, the attachment 168 is an embodiment of an angle bracket 170. The angle bracket 170 may be of any appropriate size and geometry. In some embodiments, the angle bracket 170 includes a first arm 172 and a second arm 178. In at least one embodiment, the first arm 172 is approximately orthogonal to the second arm 178.

The first arm 172 may include a first opening 174 and a second opening 176 that are each sized to receive the shaft 156 of the fastener 150. The second arm 178 comprises an attachment aperture 180. In some embodiments, the attachment aperture 180 may be elongated to define a slot. In other embodiments, the second arm 178 may optionally include at least one attachment aperture 180′ that is generally circular.

It is contemplated that the second arm 178 may optionally include a combination of elongated slot apertures 180 and generally circular apertures 180′, without departing from the scope of the present disclosure. For instance, the combination of the apertures 180, 180′ on the second arm 178 may be centrally aligned along an axis in the longitudinal dimension Z, and/or may be offset in a lateral dimension X.

In some embodiments, the first opening 174 is elongated in the vertical dimension Y to define a slot. The slot optionally has a length of between about 1.1 inch and about 1.5 inch, or about 1.3 inch.

Optionally, the first opening 174 and the second opening 176 have a width measured in the lateral dimension X of between about 0.29 inches and about 0.37 inches, or about 0.33 inches. The width of the first and second openings is selected to receive the square neck 154 of the fastener 150. This is beneficial to prevent rotation of the fastener 150 relative to the angle bracket 170 and the mounting bracket 20A. Accordingly, the nut 162 can be tightened onto the threaded shaft 156 with only one wrench, saving time during assembly and installation of the mounting bracket 20A on a roof 2.

An embodiment of the fastener 164 insertable into respective holes 130 to fix the feet 48A, 98A to the trapezoidal rib 6 is also generally illustrated in FIG. 3. The fastener 164 may be a threaded fastener, such as a sheet metal screw with a shaft that is threaded. However, any suitable fastener known to those of skill in the art may be used with the mounting bracket of the present disclosure. Accordingly, in some embodiment, one or more of the fasteners 164 may be a rivet.

As generally illustrated in FIGS. 1-9, the first and second feet 48A, 98A are oriented in the longitudinal dimension Z such that the holes 130 are on the same side of the mounting assembly 18A. It is contemplated that this is beneficial to provide access on the same side of the mounting assembly 18A, and to provide a mounting assembly 18A with a smaller footprint. In addition, it is noted this is usable, in one example, where the trapezoidal ribs 6 on a roof 2 have rails (e.g., photovoltaic rails) installed to facilitate positioning of (and access to) the first and second feet 48A, 98A without obstruction from the rails.

Referring again to FIG. 2, when the mounting bracket 20 is fixed to the roof with the first arm 172 of the angle bracket 170 oriented in the vertical dimension Y, and the second arm 178 extending in the longitudinal dimension Z away from the first surface 34 of the first flange 26A, a clamping system 186A may be used to secure one or more photovoltaic modules 196 to the mounting bracket. However, it is contemplated that the angle bracket 170 may be oriented with the first arm 172 and/or the second arm 178 in any dimensions, depending on the nature or configuration of the installation of the mounting assembly 18A (e.g., with respect to preference for a smaller footprint versus greater accessibility to the holes 130, and the like), without departing from the scope of the present disclosure.

A variety of clamping systems 186A may be secured to the angle bracket 170. One suitable clamp system 186A comprises a mounting plate 188 secured to the angle bracket 170 by a stanchion 190. A PV clamp 192 is adjustably secured to the stanchion 190 by a clamp fastener 194. In this manner, frames of one or two photovoltaic (PV) modules 196 (partially illustrated in vertical cross-section in FIG. 2) may be secured between the clamp 192 and the mounting plate 188.

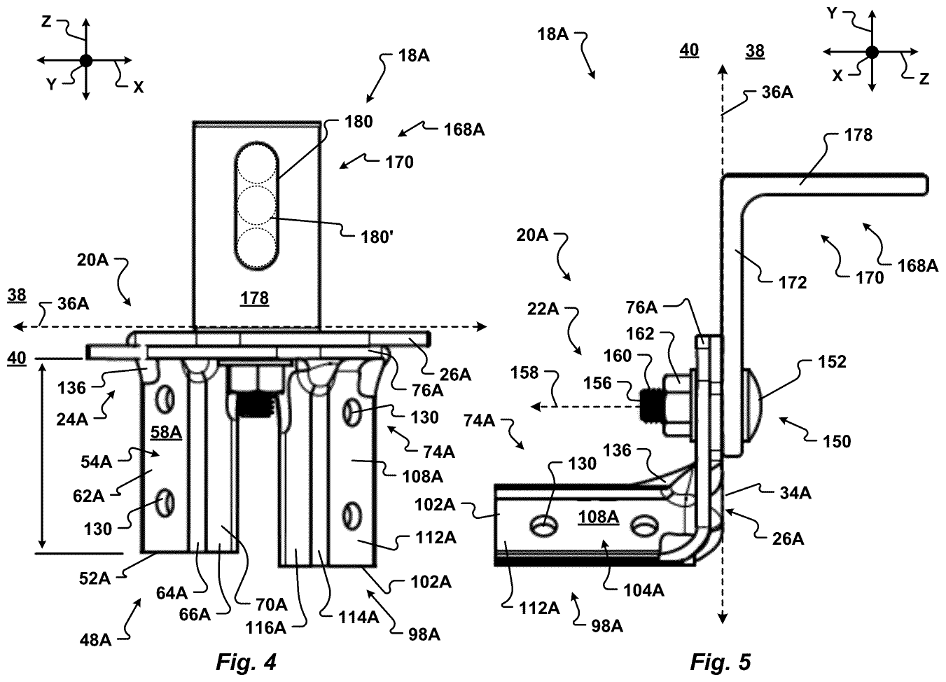

The arrangement of the angle bracket 170 on the first side 38 of the first reference plane 36 and the first and second feet 48A, 98A on the second side 40 of the first reference plane (as illustrated in FIGS. 4-5) is beneficial during installation of the photovoltaic modules 196 on the roof 2. More specifically, and referring again to FIGS. 1-2, when photovoltaic modules 196 are secured by the clamping system 186A to the angle bracket 170, the frames of the photovoltaic modules 196 will not cover or obstruct access to the holes 130 in the feet 48A, 98A. This is beneficial because it is easier to tighten the fasteners 164 necessary to secure the legs 24A, 74A to the trapezoidal rib 6.

In contrast, some prior art mounting brackets have holes for fasteners on both a first side and a second side of a vertical extension, such that at least one hole on each side of the trapezoidal rib is positioned under a frame of a photovoltaic module. Accordingly, access to the holes for the fasteners is limited, and extensions to drills and drivers are required to tighten the fasteners which makes installation more difficult. Further, as will be appreciated, taking additional tools to the job site (or up to the roof) is burdensome, time consuming and decreases efficiency.

Forming the legs 24A, 74A with feet 48A, 98A only on the second side 40 of the first reference plane is also beneficial because when the feet 48A, 98A are optionally formed with two holes 130 each for fasteners 164, both fasteners 164 of each foot 48A, 98A will resist pull out in the vertical dimension Y. For example, when a photovoltaic module 196 fixed to an angle bracket 170 positioned as generally illustrated in FIG. 1, the second arm 178 of the angle bracket is forced downwardly in the Y dimension, and the first and second feet 48A, 98A try to pull away from the trapezoidal rib and upwardly in the Y dimension. In some embodiments, as illustrated in FIG. 1, each foot 48A, 98A has two holes 130 for fasteners 164. Accordingly, all four fasteners 164 can resist the movement of the feet upwardly in the Y dimension.

In contrast, some prior art mounting brackets have holes for fasteners on both a first side and a second side of a vertical extension. This typically results in one fastener of each of two feet under a photovoltaic module (i.e., two fasteners securing the prior art mounting bracket positioned under the PV module) and one fastener of each of the two feet not being under the photovoltaic module (i.e., only two fasteners of the prior art mounting bracket are not positioned under the PV module). The applicant has found that fasteners that are not positioned under the PV module are more efficient at resisting upward movement (or lift off) of the feet of a mounting bracket.

A further unexpected benefit of the arrangement of the feet 48A, 98A of the legs 24A, 74A is that, through testing, the feet 48A, 98A could be formed with a shorter length than feet of prior art mounting brackets of similar size and while still providing sufficient strength. For example, in some embodiments of the present disclosure, the feet 48A, 98A have a length of approximately 2 inches or less. In contrast, one prior art mounting bracket has feet with a total length of four inches (with each foot extending two inches away from each side of a vertical support). However, during testing, the mounting bracket 20A of the present disclosure resists lift off force approximately equal to lift off forces that the prior art mounting bracket will resist. Accordingly, in some embodiments, the mounting bracket 20A of the present disclosure can be formed with less metallic material and yet is approximately as effective as the prior art mounting bracket formed of more metallic material.

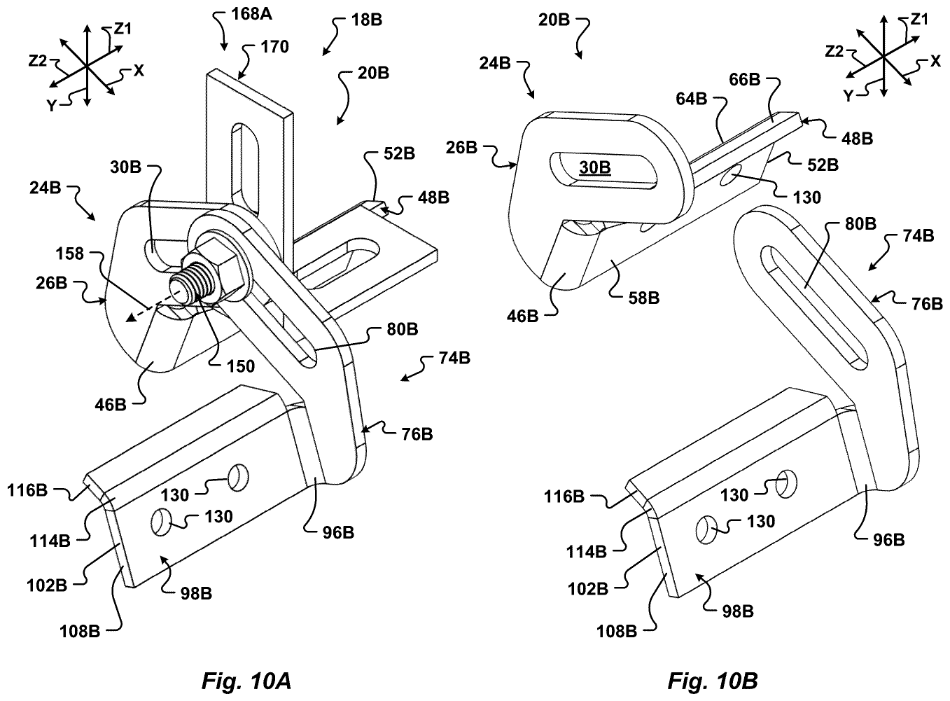

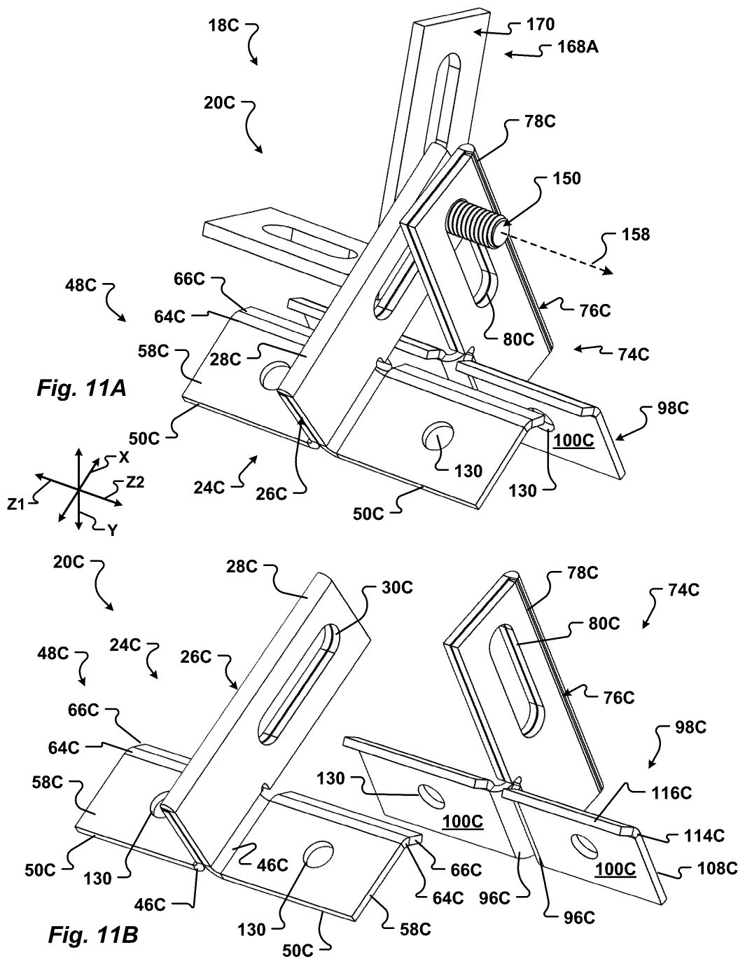

A mounting assembly 18B including a variation of the mounting bracket 20A of FIGS. 1-9 is illustrated in FIGS. 10A-10B, which is identified as mounting bracket 20B. Corresponding components between the embodiments of FIGS. 1-9 and FIGS. 10A-10B are identified by the same reference numerals. Those corresponding components that differ in at least some respect may be further identified by the letter “B” following the reference number. Unless otherwise noted herein to the contrary, the discussion of the details of the mounting bracket 20A, including the various features thereof, remains equally applicable to the mounting bracket 20B of FIGS. 10A-10B.

The mounting bracket 20B generally comprises a first leg 24B and a second leg 74B each formed from a single piece of metallic material. The first and second legs 24B, 74B may be formed by a forming apparatus as described herein in conjunction with the mounting bracket 20A.

The first leg 24B comprises a first flange 26B connected to a first foot 48B by a first bend 46B. Similarly, the second leg 74B comprises a second flange 76B connected to a second foot 98B by a second bend 96B. Notably, in some embodiments, the first and second bends are generally linear. In this regard, the first leg 24B and the second leg 74B are each of a one-piece construction, and are not welded assemblies formed from multiple pieces or components.

One difference between the mounting bracket 20B compared to mounting bracket 20A is that the upper segments 66B, 116B of the feet 48B, 98B are separated from the respective first and second flanges 26B, 76B. In some embodiments, the first and second folds 64B, 114B of the feet 48B, 98B do not extend to the flanges. The material between the flanges 26B, 76B and the upper segments 66B, 116B (and optionally the folds 64B, 114B) is removed by the forming apparatus.

Another difference is that the first foot 48B extends from the first flange 26B in a first lateral dimension Z1 and the second foot 98B extends from the second foot 98B in a second lateral dimension Z2 opposite to the first lateral dimension. Accordingly, the feet extend in opposite directions from the flanges. Moreover, the angle bracket 170 is positioned between the free ends 52B, 102B of the feet 48B, 98B

Another mounting assembly 18B including yet another variation of the mounting brackets 20A, 20B of FIGS. 1-9 and 10A-10B is illustrated in FIGS. 11A-11B, which is identified as mounting bracket 20C. Corresponding components between the embodiments of FIGS. 1-10B and FIGS. 11A-11B are identified by the same reference numerals. Those corresponding components that differ in at least some respect may be further identified by the letter “C” following the reference number. Unless otherwise noted herein to the contrary, the discussion of the details of the mounting brackets 20A, 20B, including the various features thereof, remains equally applicable to the mounting bracket 20C of FIGS. 11A-11B.

The mounting bracket 20C generally comprises a first leg 24C and a second leg 74C each formed from a single piece of metallic material. The first and second legs 24C, 74C may be formed by a forming apparatus as described herein in conjunction with the mounting bracket 20A. In this regard, the first leg 24C and the second leg 74C are each of a one-piece construction, and are not welded assemblies formed from multiple pieces or components.

The first leg 24C comprises a first flange 26C formed by folding the metallic material at a first flange fold 28C. The second flange 76C is also formed by folding the metallic material at a second flange fold 78C. Accordingly, the thickness of the first and second flanges is approximately equal to twice the thickness of the metallic material used to form the mounting bracket. In some embodiments, the thickness of the first and second flanges is approximately 0.25 inches.

The first leg 24C includes a first foot 48C formed of two first foot segments 50C having first lower segments 58C, with each first foot segment 50C connected to the first flange 26C by a first bend 46C. Similarly, the second leg 74C comprises a second foot 98C comprising two second foot segments 100C having second lower segments 108C, with each second foot segment 100C connected to the second flange 76C by second bends 96C.

Notably, the feet 48C, 98C of the mounting bracket 20C extend from the first and second flanges 26C, 76C in both the first longitudinal dimension Z1 and the second longitudinal dimension Z2. More specifically, two of the feet segments 50C, 100C extend in the first longitudinal dimension Z1 and the other two feet segments 50C, 100C extend in the second longitudinal dimension Z2.

The feet 48C, 98C have a thickness approximately equal to the metallic material from which the legs are formed. Accordingly, in some embodiments, the feet 48C, 98C have a thickness of approximately 0.125 inches.

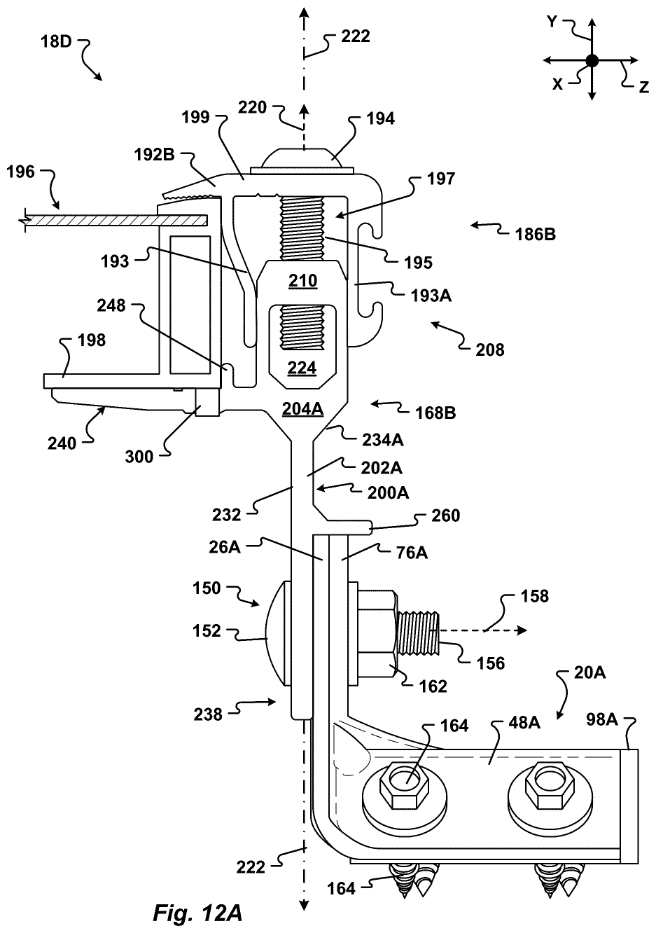

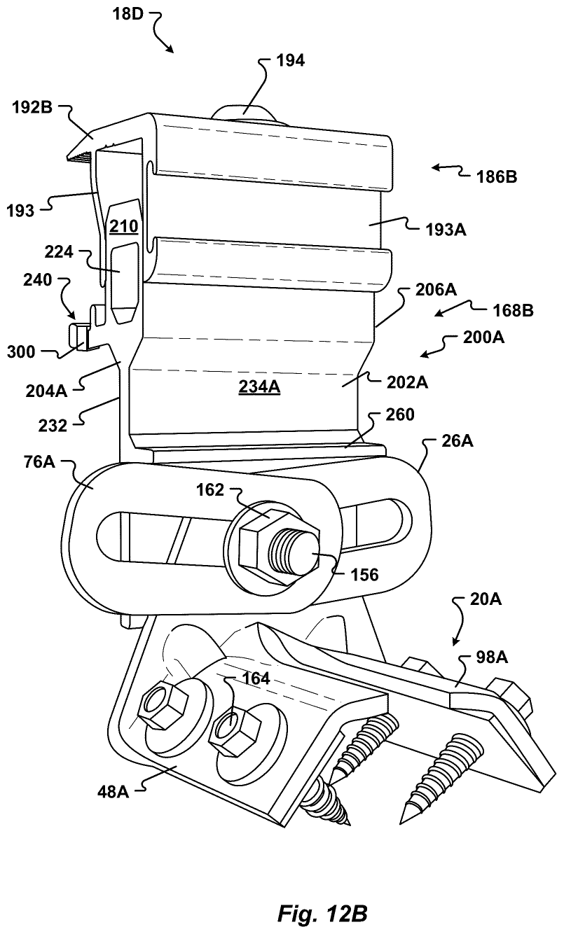

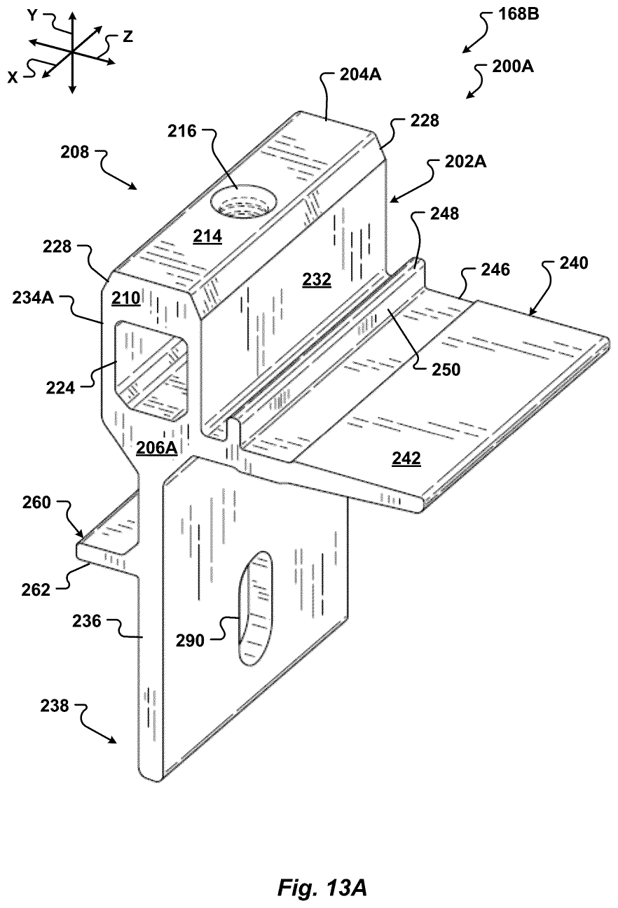

Similar to the mount bracket 20B, in some embodiments of mounting bracket 20C the upper segments 66C, 116C of the feet 48C, 98C are separated from the respective first and second flanges 26C, 76C. In some embodiments, the first and second folds 64C, 114C of the feet 48C, 98C do not extend to the flanges. The material between the flanges 26C, 76C and the upper segments 66C, 116C (and optionally the folds 64C, 114C) is removed by the forming apparatus. Referring now to FIG. 12A-12B, a mounting assembly 18D according to another embodiment of the present disclosure is generally illustrated. The mounting assembly 18D generally comprises a clamp system 186B and another embodiment of an attachment 168B that is selectively attachable to the mounting brackets 20 of all embodiments of the present disclosure. The attachment 168B is a mount 200A. Although the mount 200A is illustrated in FIG. 12A-12B interconnected to a mounting bracket 20A, alternatively the mount 200A may also be interconnected to the mounting brackets 20B, 20C of the present disclosure.

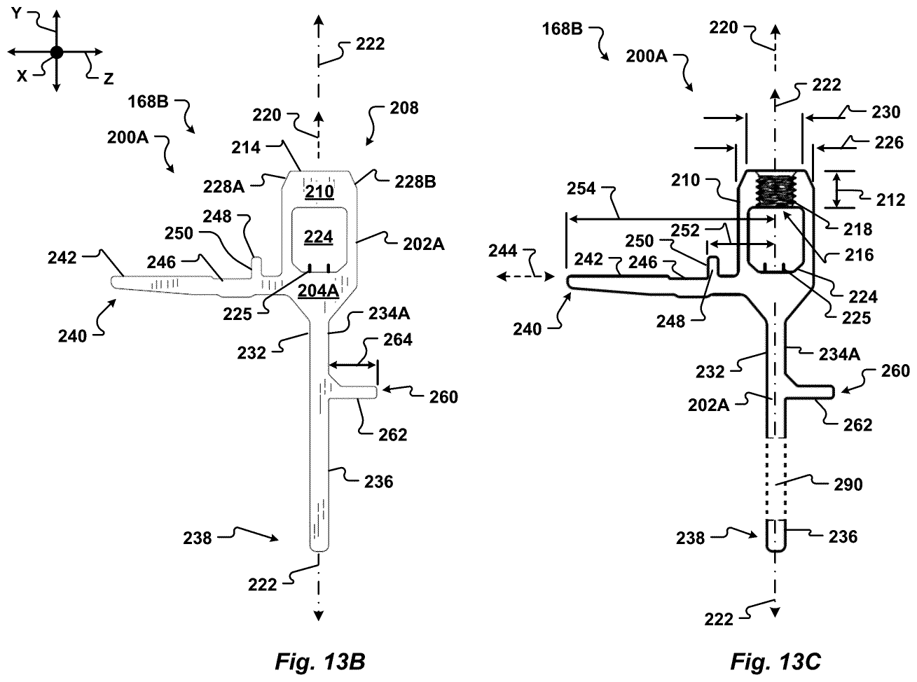

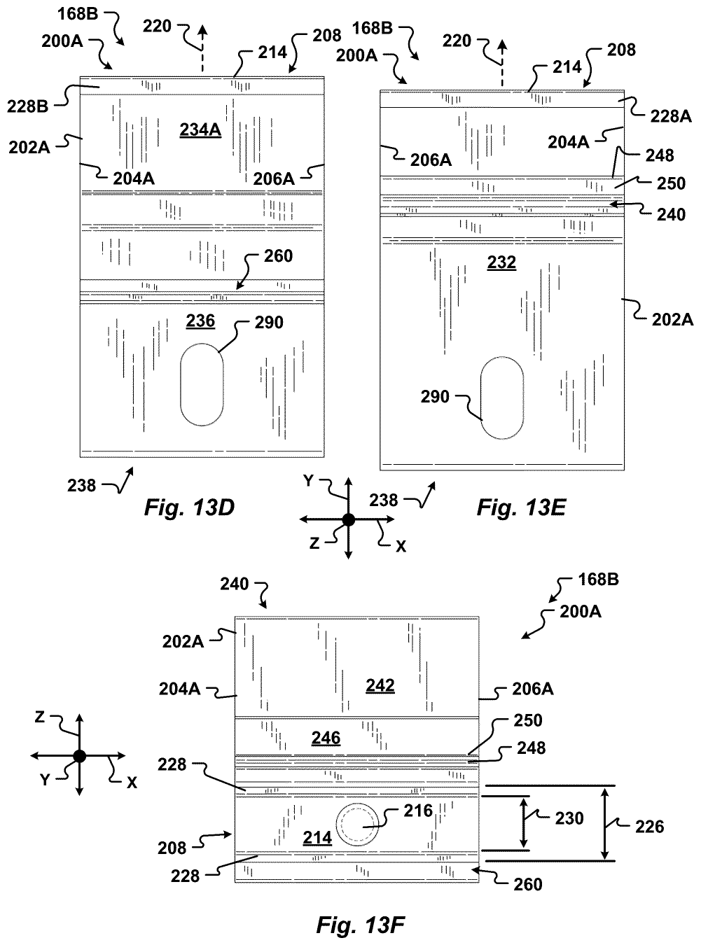

The mount 200A (which is described in more detail in conjunction with FIGS. 13A-13F as well as FIG. 12A-12B) generally comprises a body 202A configured to support one photovoltaic module 196 of a photovoltaic array. The mount 200A may thus be referred to as an “edge mount”. The body 202A is also configured to couple with (or be engaged by) a photovoltaic (PV) clamp 192B of a clamp system 186B, the PV clamp 192B being configured to engage only one PV module 196 supported by the mount 200A. The PV clamp 192B may be referred to as an “edge clamp”.

The body 202A generally comprises a first end 204A that is opposite to a second end 206A in the lateral dimension X. The body 202A has a top end 208 with a top wall 210 having a top surface 214. A first side 232 of the body 202A is spaced from a second side 234A in the longitudinal dimension Z.

The mount 200A includes a bottom end 238 opposite to the top end 208. An orifice 290 extends through a lower portion of the body 202A proximate to the bottom end 238 from the first side 232 to the second side 234A. The orifice 290 is adapted to receive a shaft 156 of a fastener 150 to interconnect the mount 200A to the mounting brackets 20 of all embodiments of the present disclosure.

Optionally, the orifice 290 is elongated in the vertical dimension Y to form a slot. Forming the orifice 290 as a slot facilitates adjustment of the mount 200 upwardly or downwardly in the vertical dimension Y during assembly of the mounting assembly 18B. Adjusting the vertical position of the mount 200A is beneficial, for example, to adjust for low spots on a roof 2. In this manner, adjacent PV modules 196 may be arranged with their upper surfaces substantially co-planar, despite any unevenness or inconsistency in the roof 2.

A top aperture 216 extends through the top surface 214 into the top wall 210. The mount 200A optionally includes two or more top apertures 216 in the top wall 210.

In some embodiments, the top aperture 216 is threaded. In these embodiments, an aperture axis 220 is concentrically aligned with the threaded top aperture 216.

In at least one embodiment, the threads of the top aperture 216 are adapted to engage a clamp fastener 194 with a shaft having a diameter of 8 mm and a thread pitch of 1.25 mm. As will be appreciated, a shaft with this geometry is commonly referred to as an M8-1.25.

Optionally, the aperture axis 220 extends in the vertical dimension Y. In at least some embodiments, a central reference plane 222 extending in the lateral dimension X and the vertical dimension Y and through the body 202A intersects the aperture axis 220. The body 202A is not symmetric with respect to the central reference plane 222.

Alternatively, in other embodiments, the top aperture is unthreaded. Additionally, or alternatively, the top aperture 216 may be elongated in the lateral dimension X to define a slot.

In at least one embodiment, a cavity 224 extends through the body 202A from the first end 204A to the second end 206A. Optionally, the top aperture 216 extends to the cavity 224.

When present, the cavity 224 beneficially reduces the amount of material used to form the mount 200A. For example, in some embodiments, the cavity 224 reduces the volume of the mount 200A by about 0.48 in³ (about 7.87 cm³), a significant reduction in the volume of material used to form the mount 200A. In some embodiments, the cavity 224 reduces the volume of the mount 200A by approximately 20 percent compared to a mount of similar dimensions and geometry formed without the cavity.

In some embodiments, and referring now to FIGS. 13B-13C, the cavity 224 optionally includes one or more protrusions 225. For example, the one or more protrusions 225 may assist in routing electrical wires, lines, or other cabling. By way of another example, the one or more protrusions 225 may provide increased strength when extruding the mount 200A along the lateral dimension X. In some non-limiting configurations, the one or more protrusions 225 may extend from the first end 204A to the second end 206A, similar to the cavity 224. It is noted that the protrusions 225 may or may not be shown to scale but, for example, may be enlarged solely for purposes of clarity in FIGS. 13B-13C.

The top wall 210 has a thickness 212 measured in the vertical dimension between the top surface 214 and an upper surface of the cavity 224. In some embodiments, the thickness 212 of the top wall is selected such that (when the top aperture 216 is threaded) there are a sufficient number of revolutions of the interior thread 218 within the top aperture 216 (e.g., at least 2.5 revolutions and, in some instances, at least four revolutions) to provide a strong engagement with the exterior threads 195 of a clamp fastener 194 of the clamp system 186B. Optionally, the thickness 212 is between about 0.25 inches and about 0.35 inches (6.35 mm and 8.89 mm), or about 0.30 inches (7.62 mm).

Proximate to the top surface, the top end 208 has a maximum width 226 of between about 0.5 and 0.7 inches (12.7 mm and 17.78) measured in the longitudinal dimension Z. In some embodiments, the maximum width 226 is about 0.6 inches (15.24 mm).

Optionally, the mount 200A may comprise one or more ramps 228 as generally illustrated in FIG. 13B. In some embodiments, a first ramp 228A is positioned between the top surface 214 and the first side 232. Additionally, or alternatively, a second ramp 228B may be positioned between the top surface 214 and the second side 234A.

When present, the ramp or ramps 228 beneficially decrease the maximum width 226 of the top end measured at the top surface 214 to a minimum width. In this manner, the ramp or ramps 228 further reduce the volume of material required to form the mount 200A.

The minimum width 230 is less than the maximum width 226. In some embodiments, the minimum width 230 is between about 0.35 inches and 0.55 inches (8.89 mm and 13.97 mm). Alternatively, in other embodiments, the minimum width is about 0.45 inches (11.43 mm).

The ramp or ramps 228 (when present) permit legs 193 of a clamp 192B to fit over the top end 208, where a cavity 197 defined between the legs 193 and a top wall 199 of the clamp 192B at least partially receives the top wall 210 with the top surface 214 of the top end 208 after the ramp or ramps 228 (when present) engage the legs 193. More specifically, in at least some embodiments, the maximum width 226 of the top end 210 is greater than a minimum interior width between ends of the legs 193 of the clamp 192B. Thus, the ramp or ramps 228 serve to spread the legs 193 and increase the minimum interior width between the ends of the legs 193.

The increased width of the maximum width 226 relative to the minimum interior width between the ends of the legs 193 of the clamp 192B is further beneficial during assembly of the clamp 192B on the mount 200A prior to engagement of a PV module 196. The maximum width 226 being greater than the minimum interior width between the legs 193 provides a frictional engagement of the legs 193 with the first and second sides near the top end 208. The frictional engagement of the legs with the first and second sides of the mount prevent unintended or inadvertent downward movement of the clamp 192B during assembly of the clamp system 186B. More specifically, the friction between the legs 193 and the mount 200A prevent the clamp from falling or sliding downwardly on the mount 200A toward the top surface 214. This is beneficial to provide a space for the PV module 196 to be received on a first PV platform 240 as generally illustrated in FIG. 12A. In contrast, if the clamp 192A dropped downward before the PV module was positioned between the clamp 192A and the first PV platform 240, the clamp 192A would block the PV module and prevent proper engagement of the PV module by the clamp 192A.

In contrast, other known clamping systems include a biasing element, such as a spring, to hold a clamp away from a mounting surface during assembly. For example, several clamp system are illustrated in U.S. Pat. No. 11,296,648 (which is incorporated herein in its entirety by reference) and include a spring to urge a clamp away from a base of the clamp system. Using a separate part (such as a spring) detrimentally increases the time required to assemble the clamp system. Moreover, requiring a separate part for the clamp system means extra parts must be ordered, kept available and brought to a job site during installation, increasing costs and decreasing efficiency.

The mount 200A further comprises a first PV platform 240 extending from the first side 232. The first PV platform 240 generally comprises a first upper surface 242 adapted to support a photovoltaic module 196.

In at least some embodiments, the first upper surface 242 is generally planar. Accordingly, the first upper surface 242 may be described as defining a first platform reference plane 244 as generally illustrated in FIG. 13C. The first platform reference plane extends in the lateral dimension X and the longitudinal dimension Z.

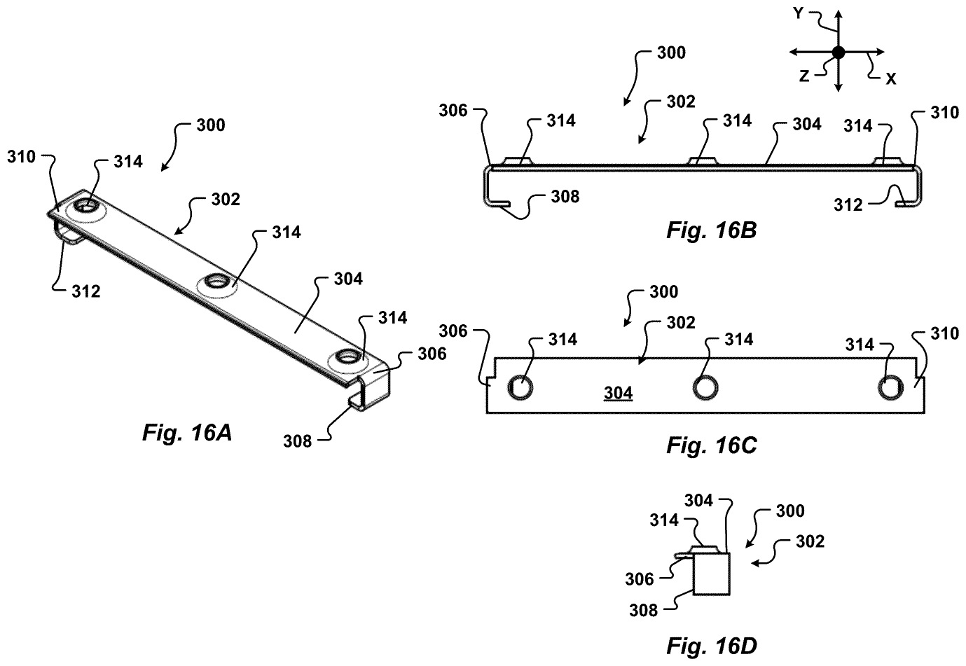

The first PV platform 240 optionally comprises a first groove 246. The first groove 246 is adapted to receive a grounding insert 300 which is generally illustrated in FIGS. 12A-12B and 16A-16D.

The first groove 246 is recessed relative to the first upper surface 242. For example, in some embodiments, the first groove is recessed about 0.02 inches (about 0.50 mm) below the first upper surface 242 measured in the vertical dimension Y. The depth of the first groove 246 beneficially ensures an upward surface 304 of the grounding insert 300 is approximately coplanar with the first platform reference plane 244.

Arranging the upward surface of the grounding insert 300 approximately coplanar with the first platform reference plane 244 is beneficial when a photovoltaic module 196 is positioned on the first PV platform 240 to prevent the frame 198 of the PV module 196 from catching on the grounding insert 300. As will be appreciated by one of skill in the art, if the frame 198 of the PV module 196 catches on the grounding insert 300, the grounding insert 300 may be dislodged from the mount 200A and prevent electrical bonding between the PV module 196 and the clamp system 186 and potential interference with a ground-fault current path.

The first groove 246 optionally extends from the first end 204A to the second end 206A of the mount 200A. When present, the first groove 246 generally extends in the lateral dimension X.

In some embodiments, the first PV platform 240 may further comprise a first stop 248. The first stop extends from the first PV platform 240 in the vertical dimension Y in the direction of the top end 208. Accordingly, the first platform reference plane 244 intersects the first stop 248.

The first stop 248 is provided to limit movement of the frame 198 of a PV module toward the central reference plane 222. A first outer surface 250 of the first stop 248 is positioned a predetermined distance 252 from the central reference plane 222 (as generally illustrated in FIG. 13C). Accordingly, the first stop 248 spaces the frame 198 a predetermined distance from the central reference plane 222 as generally illustrated in FIG. 12A. Further, in some instances, the first stop 248 is aligned with a portion of a leg 193 of the clamp 192B (e.g., an uppermost portion of a legs 19 proximate to an upper wall of the clamp 192B).

In at least some embodiments, the predetermined distance 252 is approximately equal to a maximum distance between an exterior surface of a leg 193 of the PV clamp 192B and the central reference plane 222. This is beneficial during installation to ensure the PV module is secured to both the PV clamp 192B and the first PV platform 240.

In some embodiments the predetermined distance 252 is between about 0.50 inches and about 0.60 inches (12.7 mm and 15.24 mm). Optionally, the predetermined distance 252 is about 0.56 inches (14.22 mm).

Optionally, the first outer surface 250 of the first stop 248 defines an inner surface of the first groove 246. Accordingly, the first stop 248 may be described as being between the first groove and the first side 232 of the body 202A.

The first PV platform 240 has a first length 254 extending in the longitudinal dimension Z and measured from the central reference plane 222. In some embodiments, the first length 254 is between about 1.5 inches and about 1.9 inches (3.81 cm and 4.83 cm), or about 1.7 inches (4.32 cm).

The mount 200A further comprises a mount flange 260 which extends in the longitudinal dimension Z from the second side 234A. In some embodiments, the mount flange 260 extends from the first end to the second end of the mount 200A.

When the mount 200A is interconnected to a mounting bracket 20 of any embodiment of the present disclosure with the second side 234A facing the mounting bracket 20, the mount flange 260 extends above edges of the first and second flanges 26, 76 (e.g., flanges 26A, 76A of mounting bracket 20A, as generally illustrated in FIGS. 12A and 12B). In particular, as shown in FIG. 12B, when the mounting assembly 18B is assembled, the mount flange 260 may contact one (or both) of the first and second flanges 26A, 76A. More specifically, a lower surface 262 may contact at least one of the flanges 26A, 76A. In some embodiments, the lower surface 262 is generally planar.

The contact between the mount flange 260 and one or more of the flanges 26, 76 beneficially prevents unintended and inadvertent rotation of the mount 200A around a pivot axis 158 defined by a shaft 156 of a fastener 150 interconnecting the mount 200A to the mounting bracket 20A. Moreover, when the mounting bracket 20 is attached to a building surface (such as a roof 2) that is approximately symmetrical, contact between the mount flange 260 and the flanges 26, 76 will align the first upper surface 242 of the first PV platform 240 approximately parallel to a plane defined by upper walls 12 of trapezoidal ribs 6 of the building surface. In this manner, the PV modules 196 supported by an array of mounting assemblies 18B will also be approximately parallel to the plane defined by the upper walls 12.

Because the mount flange 260 is only required to contact the flanges 26, 76, in at least some embodiments, a flange length 264 of the mount flange must only be about equal to the thicknesses of the flanges 26, 76. Accordingly, in at least one embodiment, the flange length 264 is less than about 0.50 inches (12.7 mm) as measured in the longitudinal dimension Z from a surface of the second side 234A. In some embodiments, the flange length is less than about 0.4 inches (10.2 mm). Forming the mount flange 260 with a length greater than necessary to contact the flanges 26, 76 would be a waste of the material used to form the mount 200A.

In some embodiments, a portion (e.g., a surface 236) of the second side 234A is generally planar between the mount flange 260 and the bottom end 238 of the body 202A. This planar surface 236 is beneficial to ensure the second side 234A can be drawn close to the first and second flanges 26, 76 as the nut 162 is tightened onto the fastener 150 such that the mount flange may extend above the upper surfaces of the flanges.

In at least one embodiment, between the lower surface 262 of the flange and the bottom end 238 of the mount 200A, the second side 234A is devoid of projections or protrusions. Accordingly, the planar surface 236 may run continuously from the lower surface 262 to the bottom end 238.

The mount flange 260 is optionally positioned between the first PV platform 240 and the orifice 290 in the vertical dimension Y. Further, the first PV platform is positioned between the mount flange and the top surface 214 in the vertical dimension.

The mount 200A may be formed of any suitable material. In some embodiments, the mount 200A is formed of a metal. Optionally, the metal is an aluminum alloy.

In at least one embodiment, the mount 200A is formed by an extrusion process. For example, in some embodiments, the mount does not have any bended or folded material.

Moreover, in some embodiments, the mount 200A is formed of a single piece of material. For example, in embodiments, the mount 200A does not have any pieces of material joined together by welding or fasteners. Accordingly, the mount may be described as having a unitary body 202A, or being of a one-piece (or unitary) construction.

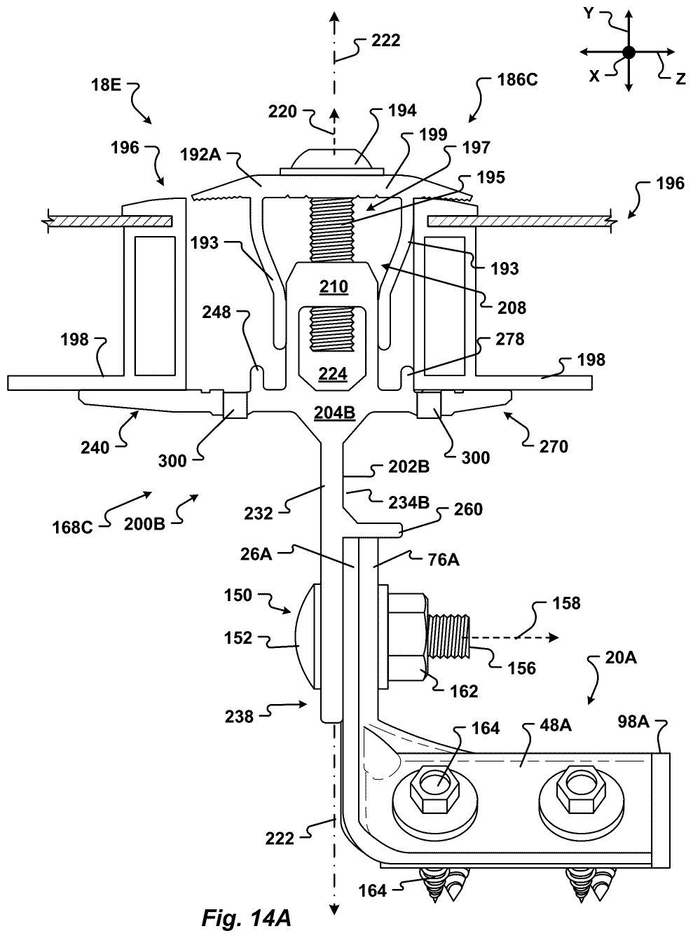

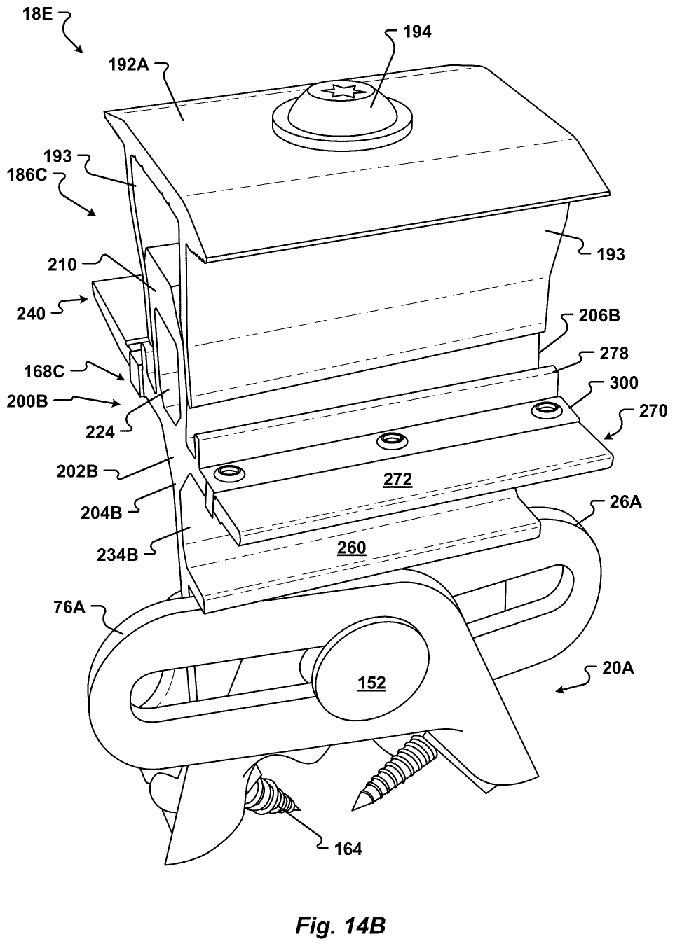

Referring now to FIG. 14A-14B, a mounting assembly 18E according to another embodiment of the present disclosure is generally illustrated. The mounting assembly 18E generally comprises a clamp system 186C and still another embodiment of an attachment 168C that is selectively attachable to the mounting brackets 20 of all embodiments of the present disclosure. The attachment 168C is a mount 200B according to another embodiment. Although the mount 200B is illustrated in FIG. 14A-14B interconnected to a mounting bracket 20A, alternatively the mount 200B may also be interconnected to mounting brackets of any embodiment, including the mounting brackets 20B, 20C of the present disclosure.

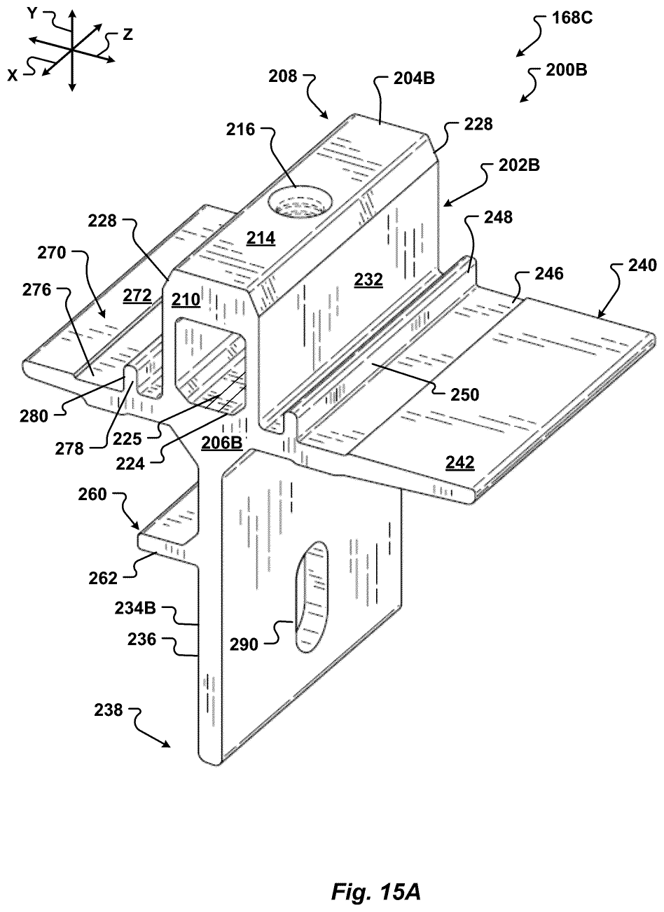

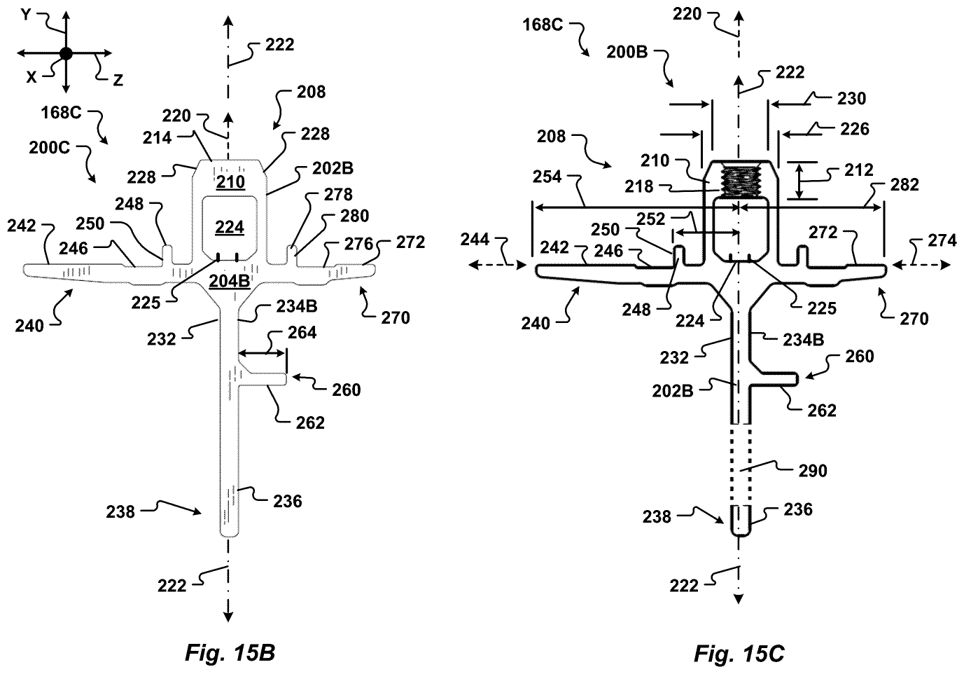

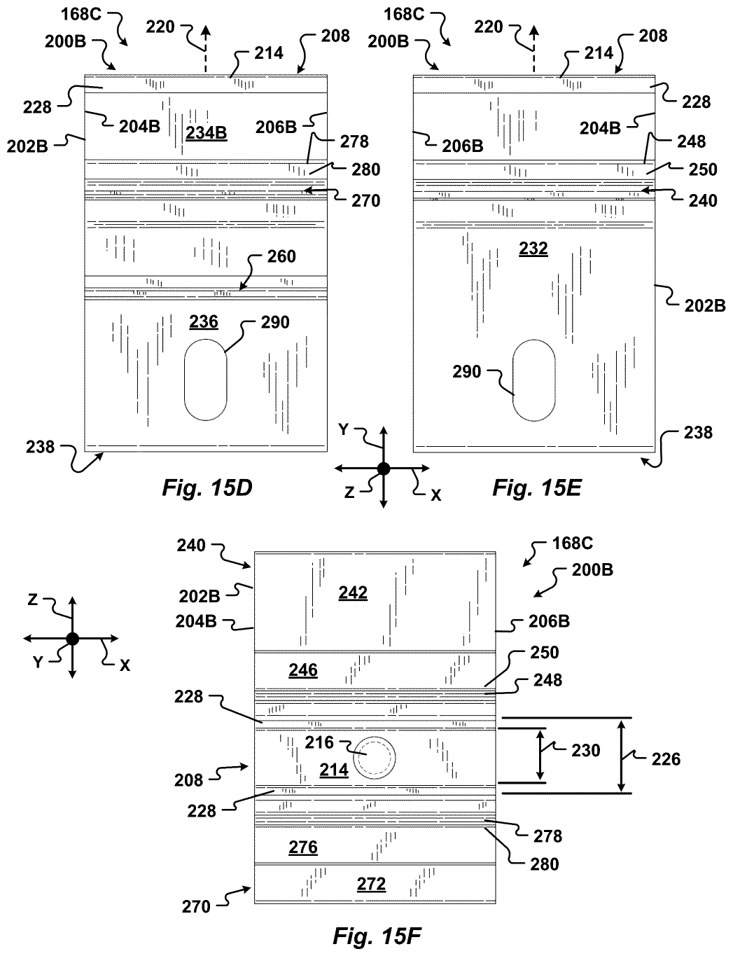

Corresponding components between the mount 200A described in conjunction with FIGS. 12A-12B and 13A-F and the mount 200B (which is described in conjunction with FIGS. 14A-14B and 15A-15F) are identified by the same reference numerals. Those corresponding components of the mount 200B that differ in at least some respect may be further identified by the letter “B” following the reference number. Unless otherwise noted herein to the contrary, the discussion of the details of the mount 200A, including the various features thereof, remains equally applicable to the mount 200B of FIGS. 14A-14B and 15A-15F.

The mount 200B generally comprises a body 202B configured to support two photovoltaic modules 196 of a photovoltaic array, with the mount 200B positioned between the two photovoltaic modules 196. The mount 200B may thus be referred to as a “mid-mount”.

The body 202B is also configured to couple with (or secure) a photovoltaic (PV) clamp 192A of a clamp system 186C. The PV clamp 192A is configured to engage two PV modules 196 supported by the mount 200B. The PV clamp 192A can thus be referred to as a “mid-clamp”.

The body 202B generally comprises a top aperture 216, a first PV platform 240, and a mount flange 260 that are the same as (or similar to) the top aperture 216, the first PV platform 240, and the mount flange 260 of the body 202A. The body 202B is not symmetric with respect to the central reference plane 222.

Optionally, the body 202B may also include a cavity 224 (e.g., with optional protrusions 225) that is the same as or similar to the cavity of the body 202A. The cavity (when present) has the same benefits as in the body 202A and beneficially decreases the volume of the body 202B. For example, without the cavity, the volume of the body 202B would be about 2.71 in³ (about 44.41 cm³), and the cavity has a volume of about 0.48 in³ (about 7.87 cm³). Accordingly, the body 202B with the cavity has a volume of only about 2.23 in³ (about 36.54 cm³). Thus, the cavity reduces the volume of the body 202B by about 18 percent. This is a significant savings in the volume of material required to form the mount 200B and results in substantial cost savings. It is noted that the optional protrusions 225 may or may not be shown to scale but, for example, may be enlarged solely for purposes of clarity in FIGS. 15B-15C.

Notably, the body 202B comprises a second PV platform 270 extending from the second side 234B. The second PV platform 270 generally comprises a second upper surface 272 adapted to support a second photovoltaic module 196.

In at least some embodiments, the second upper surface 272 is generally planar. Accordingly, the second upper surface 272 may be described as defining a second platform reference plane 274. The second platform reference plane 274 extends in the lateral dimension X and the longitudinal dimension Z.

In at least some embodiments, the second PV platform 270 is positioned approximately opposite to the first PV platform 240 relative to the central reference plane 222. Accordingly, in at least one embodiment, the first and second platform reference planes 244, 274 are coplanar.

The second PV platform 270 optionally comprises a second groove 276. The second groove 276 is adapted to receive a grounding insert 300 such as generally illustrated in FIGS. 14A and 16A-16D.

The second groove 276 is recessed relative to the second upper surface 272. For example, in some embodiments, the second groove 276 is recessed about 0.02 inches (about 0.50 mm) below the second upper surface 272 measured in the vertical dimension Y. The depth of the second groove 276 beneficially ensures an upward surface 304 of the grounding insert 300 is approximately coplanar with the second platform reference plane 274 and thus provides similar benefits as the first groove 246.

The second groove 276 optionally extends from the first end 204B to the second end 206B of the mount 200B. When present, the second groove 276 generally extends in the lateral dimension X.

In some embodiments, the second PV platform 270 may further comprise a second stop 278. The second stop 278 is provided to limit movement of the frame 198 of the second PV module toward the central reference plane 222. The second stop 278 extends from the second PV platform 270 in the vertical dimension Y in the direction of the top end 208. Accordingly, the second platform reference plane 274 intersects the second stop 278.

A second outer surface 280 of the second stop is positioned a predetermined distance from the central reference plane 222. Accordingly, the second stop 278 spaces the frame 198 a predetermined distance from the central reference plane 222. The second stop 278 is optionally positioned the same distance from the central reference plane 222 as the first stop 248. More specifically, in some embodiments, the first and second stops are approximately symmetrically arranged with respect to the central reference plane 222. Further, in some instances, the first and second stops 248, 278 are aligned with a portion of the legs 193 of the clamp 192A as generally illustrated in FIG. 14A (e.g., an uppermost portion of the legs 193 proximate to an upper wall of the clamp 192A).

In at least some embodiments, the predetermined distance provided between the second outer surface 280 and the central reference plane 222 is approximately equal to a maximum distance between an exterior surface of the legs 193 of the PV clamp 192A and the central reference plane 222. This is beneficial during installation to ensure the PV module 196 is secured to both the PV clamp and the second PV platform 270.

In some embodiments, the predetermined distance between the second outer surface 280 and the central reference plane 222 is between about 0.50 inches and about 0.60 inches (12.7 mm and 15.24 mm). Optionally, the predetermined distance is about 0.56 inches (14.22 mm).

Optionally, the second outer surface 280 of the second stop 278 defines an inner surface of the second groove 276. Accordingly, the second stop 278 may be described as being between the second groove 276 and the second side 234B of the body 202AB.

The second PV platform 270 has a second length 282 extending in the longitudinal dimension Z and measured from the central reference plane 222. In at least one embodiment, the second length 282 is less than the first length 254. Forming the second PV platform 270 with a second length 282 which is shorter than the first length 254 of the first PV platform 240 is beneficial to save material used to form the mount 200B. The second PV platform 270 may be formed with a second length that is shorter than the first length.

In some non-limiting examples of an installation procedure, a mount 200A of FIGS. 12A-12B or a mount 200B of FIGS. 14A-14B may be installed on a roof 2, as well as a mount 200B. Next, a first side of the frame of a first PV module 196 is typically positioned of the PV platform 240 of the mount 200A or mount 200B. Further, a second side of the frame 198 of the first PV module 196 is lowered onto the second PV platform 270 of a mount 200B. It is noted the first PV platform 240 is made with a longer first length to aid engagement when the installer lifts the first PV module 196 and pushes it toward the first stop 248. Once the first side of the frame 198 of the first PV module 196 is on the first PV platform 240 of the mount 200A or mount 200B, it is typically easy to position the second side of the frame 198 of the first PV module 196 on the second PV platform 270 by merely lowering the second side of the frame 198 while the first PV module 196 is supported by the mount 200A or the mount 200B. Accordingly, the second PV platform 270 does not need to have a second length equal to the first length. It is noted the installation process can continue with additional PV modules 196 being installed on mounts 200A, 200B in a similar fashion.

It should be understood that FIG. 12A illustrates a first side of a first frame 198 of a first PV module 196 (e.g., positioned on the PV platform 240 and insert 300, and before being pushed up against the optional stop 248, of the mount 200A). In addition, FIG. 14A illustrates an installed second side of the first frame 198 of the first PV module 196 (e.g., positioned on the PV platform 270 and insert 300, with the first frame pushed up against the optional stop 278 of the mount 200B), and the pre-installation of the first side of the second frame 198 of a second PV module 196 (e.g., on the PV platform 240 of the mount 200B).

In general, one option for the installation procedure is to “advance the column upward”, or to position the mounts 200A, 200B such that PV modules 196 are installed from a low point on a roof 2 to a high point on a roof 2. In this regard, the installer can make use of gravity during installation, relying on gravity to assist in holding the PV module 196 on the first PV platform 240 while the PV module 196 is installed on the second PV platform 270.

In some embodiments, the second length 282 is between about 1 inch and about 1.41 inches (2.54 cm and 3.58 cm). Optionally, second length 282 is about 1.21 inches (3.07 cm).

The mount 200B may be formed of any suitable material. In some embodiments, the mount 200B is formed of a metal. Optionally, the metal is an aluminum alloy.

In at least one embodiment, the mount 200B is formed by an extrusion process. For example, in some embodiments, the mount does not have any bended or folded material.

Moreover, in some embodiments, the mount 200B is formed of a single piece of material. For example, in embodiments, the mount 200B does not have any pieces of material joined together by welding or fasteners. Accordingly, the mount may be described as having a unitary body 202B, or being of a one-piece (or unitary) construction.

In some embodiments, the mounts 200A, 200B are fabricated through an extrusion process, after which a drilling process is then performed for hole 216 and a punching process is performed for hole 290. It is noted that cavity 224 is hollow for weight reduction and to provide space for the drilling when forming the hole 216 without needing a blind hole during the drilling process.

Referring now to FIGS. 16A-16D, a grounding insert 300 according to embodiments of the present disclosure is generally illustrated. The grounding insert 300 is configured to engage grooves 246, 276 of PV platforms 240, 270 of the mounts 200A, 200B, to both bond and ground frames 198 of PV modules 196 installed on the PV platforms 240, 270 to the mounts 200A, 200B.

The grounding insert generally comprises an insert body 302 which has a first end 306 spaced from a second end 310. The first end comprises a first hook 308 to engage an edge of a PV platform 240, 270 (e.g., positioned at one end 204, 206 of the PV platforms 240, 270). The second end comprises a second hook 312 to engage an opposite edge of the PV platform (e.g., positioned at an opposite end 204, 206 of the PV platforms 240, 270). In this manner, the grounding insert 300 may be engaged to a mount 200A, 200B and positioned partially in a first groove 246 or a second groove 276.

The insert body 302 has an upward surface 304 positioned between the hooks 308, 312. At least one dimple 314 extends upwards from the upward surface. In some embodiments, the insert body 302 includes two dimples. In at least one embodiment, three dimples 314 are formed on the grounding insert. The dimple or dimples provide contact with a frame 198 of a PV module to electrically bond and ground the frame 198 of the PV module 196 to the mounting assembly 18D, 18E.

The grounding insert 300 is made of a material that is electrically conductive. In some embodiments, the grounding insert 300 comprises a stainless steel. It is noted that the stainless steel is of an increased strength to cause the grounding insert 300 to locate into the respective groove 246, 276 instead of needing to further modify the mount 200A, 200B (e.g., from its original extruded state) to receive fasteners, press-fit pins, or the like used to bond and ground the frame 198 of the PV module 196 to the PV platforms 240, 270. However, other materials (and other metals) are contemplated.

The mounting brackets 20 of embodiments of the present disclosure provide many benefits. For example, the mounting brackets 20 described herein fit many trapezoidal ribs of a variety of different shapes and sizes. Some embodiments of the mounting brackets 20 of the present disclosure may be adjusted from a minimum width of about 0.67 inch (17.04 mm) to a minimum width of about 3.75 inch (95.18 mm). Accordingly, instead of stocking many different mounting devices to fit various different trapezoidal ribs, the mounting brackets of the present disclosure may be used on the various different trapezoidal ribs, reducing inventory costs associated with ordering, shipping, storing, and accounting for mounting devices of multiple sizes and types. In this regard, the present disclosure provides a solution to a long-felt but unsolved need for a mounting bracket that is adjustable to engage trapezoidal ribs of different shapes and sizes and that can be used to install a variety of structures on building surfaces.

In some embodiments, the mounting brackets 20 are formed of an aluminum alloy. This is beneficial as aluminum is lighter than other materials frequently used to form mounting devices, resulting in reductions in shipping costs.

Another benefit of the mounting brackets 20 of embodiments of the present disclosure is that they are formed without welding. Specifically, the mounting brackets 20 of all embodiments the present disclosure are formed by bending or shaping a metal blank (such as a continuous sheet of metal from a coil). In contrast, some known mounting devices for trapezoidal ribs are formed by welding or otherwise joining multiple pieces of metal together. As will be appreciated by one of skill in the art, forming a mounting devices by welding is time consuming and expensive.

Another benefit is that the mounting brackets 20 of all embodiments of the present disclosure may be used to mount photovoltaic modules to trapezoidal rib panels with or without rails. Further, the mounting brackets 20 alleviate the necessity for a fastener to extend to an underlying deck or to another surface (such as a purlin) below the trapezoidal rib panels. This feature of the mounting brackets 20 provides significant flexibility when arranging and installing photovoltaic modules on a roof formed of trapezoidal rib panels.

While various embodiments of the system and method have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items. Further, it is to be understood that the claims is not necessarily limited to the specific features or steps described herein. Rather, the specific features and steps are disclosed as embodiments of implementing the claimed systems and methods.

One aspect of the disclosure comprises any of one or more of the aspects/embodiments as substantially disclosed herein.

Another aspect of the disclosure is any of one or more of the aspects/embodiments as substantially disclosed herein optionally in combination with any of one or more other aspects/embodiments as substantially disclosed herein.

It is another aspect of the present disclosure to provide one or more means adapted to perform any of one or more of the above aspects/embodiments as substantially disclosed herein.

To provide additional background, context, and to further satisfy the written description requirements of 35 U.S.C. § 112, the following references are incorporated by reference herein in their entireties: U.S. Pat. Nos. 8,833,714; 9,611,652; 10,443,896; and 10,903,785.

What is claimed is:

1. A mounting bracket with a width that is adjustable to engage a trapezoidal rib projecting from a building surface, the mounting bracket comprising:
a first leg, comprising:
a first flange with a first aperture; and
a first foot connected to the first flange by a first bend, the first foot comprising a first outer surface, a first inner surface opposite the first outer surface, and a first hole extending through the first inner surface and the first outer surface, wherein a first portion of the first inner surface faces a first rib sidewall of a trapezoidal rib when the mounting bracket is secured to the trapezoidal rib;
a second leg, comprising:
a second flange with a second aperture; and
a second foot connected to the second flange by a second bend, the second foot comprising a second outer surface, a second inner surface opposite the second outer surface, and a second hole extending through the second inner surface and the second outer surface, wherein a first portion of the second inner surface faces a second rib sidewall of the trapezoidal rib when the mounting bracket is secured to the trapezoidal rib; and
a fastener comprising a shaft operable to extend through the first and second apertures to interconnect the first leg to the second leg at a point of interconnection.

2. The mounting bracket of claim 1, wherein the first foot extends from the first leg in a longitudinal direction, and the second foot extends from the second leg in the same longitudinal direction.

3. The mounting bracket of claim 1, wherein at least one of:
the first foot comprises a first upper segment connected to a first lower segment by a first fold, wherein the first portion of the first inner surface is associated with the first lower segment of the first foot; and
the second foot comprises a second upper segment connected to a second lower segment by a second fold, wherein the first portion of the second inner surface is associated with the second lower segment of the second foot.

4. The mounting bracket of claim 3, wherein the first bend is formed between the first flange and at least one of the first lower segment and the first upper segment of the first foot; and/or
wherein the second bend is formed between the second flange and at least one of the second lower segment and the second upper segment of the second foot.

5. The mounting bracket of claim 1, wherein at least one of:
the first aperture of the first flange is a first elongated slot; and
the second aperture of the second flange is a second elongated slot.

6. The mounting bracket of claim 1, wherein at least one of:
the first leg is of a one-piece construction and is formed from a single piece of a metal material; and
the second leg is of a one-piece construction and is formed from a single piece of the metal material.

7. The mounting bracket of claim 1, further comprising an angle bracket, the angle bracket comprising:
a first arm with one or more of a first opening and a second opening; and
a second arm with an attachment aperture, wherein the shaft of the fastener is selectively extendable through either the first opening or the second opening to interconnect the angle bracket to the first leg and the second leg.

8. A mount to interconnect a photovoltaic module to a mounting bracket having an adjustable width and that is securable to a trapezoidal rib projecting from a building surface, the mount comprising:
a body with a top end including a top surface;
a top aperture extending through the top surface;
a first PV platform extending outward from a first side of the mount, wherein the first PV platform comprises a first upper surface adapted to selectively support the photovoltaic module; and
an orifice extending through the first side of the mount, the orifice configured to receive a shaft of a fastener to interconnect the mount to the mounting bracket.

9. The mount of claim 8, further comprising:
a groove within the first upper surface of the first PV platform, wherein the groove is operable to receive a grounding insert with at least one dimple that extends upward to engage a frame of the photovoltaic module when selectively supported.

10. The mount of claim 8, further comprising:
a second PV platform extending outward from a second opposite side of the mount, wherein the second PV platform comprises a second upper surface adapted to selectively support a second photovoltaic module.

11. The mount of claim 10, further comprising:
a groove within the second upper surface of the second PV platform, wherein the groove is operable to receive a grounding insert with at least one dimple that extends upward to engage a frame of the second photovoltaic module when selectively supported.

12. The mount of claim 10, wherein the first PV platform is a first length in a first direction of extension outward from the first side of the mount, wherein the second PV platform is a second length in a second direction of extension outward from the second opposite side of the mount, and wherein the first length is longer than the second length.

13. The mount of claim 10, wherein at least one of:
the first PV platform has a first stop proximal to the first side of the mount, wherein a frame of the photovoltaic module makes contact with the first stop when selectively supported by the first PV platform, and wherein the first stop is configured to space the frame of the photovoltaic module a first predetermined distance from a central reference plane through the body; and
the second PV platform has a second stop proximal to the second opposite side of the mount, wherein a frame of the second photovoltaic module makes contact with the second stop when selectively supported by the second PV platform, and wherein the second stop is configured to space the frame of the second photovoltaic module a second predetermined distance from the central reference plane through the body,
wherein the second predetermined distance is substantially equal to the first predetermined distance.

14. The mount of claim 8, wherein a cavity extends through the body between a first end and a second end of the body.

15. The mount of claim 8, wherein the body is of a one-piece construction and is formed from a single piece of a metal material.

16. The mount of claim 8, further comprising a mount flange extending from a second opposite side of the mount, wherein the first PV platform is positioned between the mount flange and the top surface in a vertical dimension.

17. The mount of claim 16, wherein the mount flange is positioned between the first PV platform and the orifice in the vertical dimension such that contact between the mount flange and the mounting bracket will prevent inadvertent rotation of the mounting bracket around an axis of the fastener when the mount flange is interconnected to the mounting bracket.

18. A mounting system to engage a trapezoidal rib projecting from a building surface and secure a photovoltaic module to the building surface, the mounting system comprising:
a mounting bracket with an adjustable width, comprising:
a first leg, comprising:
a first flange with a first aperture; and
a first foot connected to the first flange by a first bend, wherein a first portion of a first inner surface of the first foot faces a first rib sidewall of the trapezoidal rib when the mounting bracket is secured to the trapezoidal rib;
a second leg, comprising:
a second flange with a second aperture; and
a second foot connected to the second flange by a second bend, wherein a first portion of a second inner surface of the second foot faces a second rib sidewall of the trapezoidal rib when the mounting bracket is secured to the trapezoidal rib; and
a fastener comprising a shaft operable to extend through the first and second apertures to interconnect the first leg to the second leg at a point of interconnection; and
a mount to interconnect the photovoltaic module to the mounting bracket, the mount comprising:
a body with a top end including a top surface;
a top aperture extending through the top surface;
a first PV platform extending outward from a first side of the mount, wherein the first PV platform comprises a first upper surface adapted to selectively support the photovoltaic module; and
an orifice extending through the first side of the mount, the orifice configured to receive the shaft of the fastener to interconnect the mount to the mounting bracket at the point of interconnection.

19. The mounting system of claim 18, further comprising:
a clamp adapted to selectively support the photovoltaic module, the clamp couplable to the top end of the mount, the clamp including a first leg and a second leg defining a cavity therebetween, wherein the top surface has a width that is less than a width of the cavity defined between the first leg and the second leg, and wherein a portion of the body proximate the top end has a second width that is greater than the width of the cavity such that the first leg provides a friction fit with at least the first side of the mount when the clamp is coupled to the top end of the mount.

20. The mounting system of claim 18, further comprising:
a second PV platform extending outward from a second opposite side of the mount, wherein the second PV platform comprises a second upper surface adapted to selectively support a second photovoltaic module.
